(19) United States
(12) Patent Application Publication
(10) Pub. No.: US 2026/0065913 A1
(43) Pub. Date: Mar. 5, 2026

(54) SINGING VOICE DEEPFAKE DETECTION

(71) Applicant: PINDROP SECURITY, INC., Atlanta, GA (US)

(72) Inventors: Hemlata Tak, Atlanta, GA (US); Ricardo Casal, Atlanta, GA (US); Ganesh Sivaraman, Atlanta, GA (US); Elie Khoury, Atlanta, GA (US)

(73) Assignee: PINDROP SECURITY, INC., Atlanta, GA (US)

(21) Appl. No.: 19/309,516

(22) Filed: Aug. 25, 2025

Related U.S. Application Data
(60) Provisional application No. 63/688,065, filed on Aug. 28, 2024.

(51) Int. Cl. G10L 17/02; G10L 17/04; G10L 17/18

(52) U.S. Cl. CPC G10L 17/02; G10L 17/04; G10L 17/18

(57) ABSTRACT

Disclosed are systems and methods including software processes executed by a server that detect machine-generated synthetic singing vocals in a vocal audio signal of an audio signal using a multi-stage machine-learning architecture. A singing detector identifies vocal segments containing singing. A singing liveness detector includes a fakeprint embedding extractor that extracts fakeprint feature vector embeddings representing artifacts of machine-generated vocal signals, scoring layers or classifier layers to generate a singing liveness score for identifying the likelihood a vocal signal is human-generated or synthetic. An optional singer detector includes a vocalprint embedding extractor that extracts vocalprint feature vector embeddings representing singer-specific vocal identity characteristics and generates a singer identification score or attribution score for identifying a particular singer in the vocal signal.

### CROSS-REFERENCE TO RELATED APPLICATIONS

The application claims the benefit of U.S. Provisional Application No. 63/688,065, filed Aug. 28, 2024, which is incorporated by reference in its entirety.

### TECHNICAL FIELD

This application generally relates to systems and methods for managing, training, and deploying a machine-learning architecture for detecting instances of machine-generated singer vocals.

### BACKGROUND

Recent advances in generative audio modeling have enabled the creation of synthetic singing voices that closely mimic the acoustic and stylistic characteristics of human vocal performances. These technologies, which include neural vocoders, text-to-singing systems, and voice cloning frameworks, have been used to generate singing content that is perceptually similar to recordings of real human singers.

Conventional biometric and anti-spoofing systems for detecting synthetic audio have primarily focused on speech-based applications, such as speaker verification, liveness detection, and spoofing countermeasures. These conventional systems typically rely on acoustic features and classification models trained on training dataset of spoken language corpora. In conventional approaches, machine-learning architectures ingest, process, and analyze audio signals containing speech signals that originate from speaking users. However, the acoustic features of audio signals containing vocal signals representing singing as originated by singing users differ significantly from those of audio signals containing speech signals in several respects, including, for example, pitch range, phoneme duration, harmonic structure, and the presence of musical accompaniment. As a result, existing speech-optimized detection systems often fail to generalize to, and accurately identify, instances of singing in audio signals.

### SUMMARY

Disclosed herein are systems and methods capable of addressing the above-described shortcomings and may also provide any number of additional or alternative benefits and advantages. Embodiments disclosed herein include systems and methods for detecting machine-generated singing vocals in audio signals using a multi-stage machine-learning architecture. The machine-learning architecture comprises a singing detector having machine-learning layers programmed and trained to identify vocal segments containing singing, a singer detector having machine-learning layers programmed and trained to extract vocalprint embeddings representing singer-specific vocal identity characteristics and identify a particular singer, and a liveness detector having machine-learning layers programmed and trained to extract fakeprint embeddings representing synthesis-related (sometimes referred to as machine-generated) artifacts and generate a singer liveness score indicating a likelihood that the vocal audio signal is human-generated or machine-generated. In some implementations, the system applies score-level fusion to combine outputs from the singer detector and liveness detector to generate a final classification score for the input audio signal. In some implementations, the system supports artist-specific vocalprint enrollment for attribution and impersonation detection, and applies singing-specific data augmentation techniques including pitch shifting, tempo perturbation, tremolo modulation, loudness normalization, and compression artifact simulation to improve model robustness.

Embodiments may include a computer-implemented method for detecting machine-generated singing in audio signals, the method including: obtaining, by a computer, an input audio signal containing singing vocal audio signal; identifying, by the computer, one or more segments of the input audio signal containing the vocal audio signal by applying a singing detector to the input audio signal; extracting, by the computer, a fakeprint embedding for the input audio signal by applying a fakeprint embedding extractor to a first set of acoustic features representing machine-related artifacts of the vocal audio segment; generating, by the computer, a singing liveness score for the input audio signal by applying a liveness detector to the fakeprint embedding, the singing liveness score indicating a likelihood that the vocal audio segment of the input audio signal is human-generated or machine-generated; classifying, by the computer, based on the liveness score for the input audio signal, the singing vocal audio signal as containing machine-generated singing vocals or human-generated singing vocals.

The method may include at a training phase: training, by the computer, the singing liveness detector for generating the liveness score using a training corpus including a plurality of training label and a corresponding plurality of training audio signals having training vocal audio signals, a training label indicating a corresponding training audio signal includes human-generated vocal audio signal or machine-generated vocal audio signal; and updating, by the computer, one or more parameters of the singing liveness detector based on a loss function using each training audio signal and each training label.

The method may include at an enrollment phase, extracting, by the computer, one or more enrolled fakeprint embeddings by applying the fakeprint embedding extractor to one or more enrollment vocal audio signals of one or more enrollment audio signals having known machine-generated vocal audio signals. The computer generates the liveness score for the input audio signal based upon comparing the input audio fakeprint against at least one enrolled fakeprint embedding.

The first set of acoustic features may be used to generate the fakeprint embedding representing at least one of: pitch smoothing, phoneme distortion, unnatural transitions, or timbre flattening.

The method may include, at a deployment phase: extracting, by the computer, an input vocalprint embedding for the input audio signal by applying a vocalprint embedding extractor of a singer detector to a second set of acoustic features representing a singer-specific vocal identity of the vocal audio signal of the input audio signal; and generating, by the computer, a singer score indicating an enrolled singer in the vocal audio signal using the singer detector, based upon comparing the input vocalprint embedding and one or more enrolled vocalprint embeddings.

The method may include identifying, by the computer, the enrolled singer in the vocal audio signal using the singer detector based upon comparing the singer score against a singer detection threshold.

The method may include, at an enrollment phase: extracting, by the computer, an enrolled vocalprint embedding for the enrolled singer by applying the vocalprint embedding extractor to the second set of acoustic features representing the singer-specific vocal identity of an enrollment vocal audio signal of an enrollment audio signal.

The method may include, at a training phase, training, by the computer, the singer detector for generating the singer score using a training corpus including a plurality of training labels and a corresponding plurality of training audio signals having training vocal audio signals, a training label indicating a corresponding training audio signal includes the singer-specific vocal identity of the training vocal audio signal of the training audio signal; and updating, by the computer, one or more parameters of the singer detector based on a loss function using one or more training audio signals and one or more training label.

The second set of acoustic features used to generate the vocalprint embedding representing at least one of: pitch contours, timbral texture, vibrato patterns, phoneme elongation, or harmonic structure.

The method may include segmenting, by the computer, the input audio signal into a plurality of time-based segments; identifying, by the computer, one or more vocal audio segments by applying a singing detector to the plurality of time-based segments to identify each time-based segment having a vocal audio segment; and generating, by the computer, the vocal audio signal having one or more vocal audio segments of the plurality of segments of the input audio signal.

Embodiments may include a system for detecting machine-based singing in audio signals. The system may includes a computer including at least one processor, configured to: obtain an input audio signal containing a singing vocal audio signal; identify one or more segments of the input audio signal containing the vocal audio signal by applying a singing detector to the input audio signal; extract a fakeprint embedding for the input audio signal by applying a fakeprint embedding extractor to a first set of acoustic features representing machine-related artifacts of the vocal audio segment; generate a liveness score for the input audio signal by applying a liveness detector to the fakeprint embedding, the singing liveness score indicating a likelihood that the vocal audio segment of the input audio signal is human-generated or machine-generated; and classify the singing vocal audio signal as containing machine-generated singing vocals or human-generated singing vocals based on the singing liveness score.

The computer may be further configured to, at a training phase: train the singing liveness detector for generating the liveness score using a training corpus including a plurality of training labels and a corresponding plurality of training audio signals having training vocal audio signals, each training label indicating whether a corresponding training audio signal includes human-generated or machine-generated vocal audio; and update one or more parameters of the singing liveness detector based on a loss function using each training audio signal and each training label.

The computer may be further configured to, at an enrollment phase: extract one or more enrolled fakeprint embeddings by applying the fakeprint embedding extractor to one or more enrollment vocal audio signals of one or more enrollment audio signals having known machine-generated vocal audio signals; and generate the liveness score for the input audio signal based upon comparing the input audio fakeprint against at least one enrolled fakeprint embedding.

The first set of acoustic features may be used to generate the fakeprint embedding includes at least one of: pitch smoothing, phoneme distortion, unnatural transitions, or timbre flattening.

The computer may be further configured to, at a deployment phase: extract an input vocalprint embedding for the input audio signal by applying a vocalprint embedding extractor of a singer detector to a second set of acoustic features representing a singer-specific vocal identity of the vocal audio signal of the input audio signal; and generate a singer score indicating an enrolled singer in the vocal audio signal using the singer detector, based upon comparing the input vocalprint embedding and one or more enrolled vocalprint embeddings.

The computer may be further configured to identify the enrolled singer in the vocal audio signal using the singer detector based upon comparing the singer score against a singer detection threshold.

The computer may be further configured to, at an enrollment phase: extract an enrolled vocalprint embedding for the enrolled singer by applying the vocalprint embedding extractor to the second set of acoustic features representing the singer-specific vocal identity of an enrollment vocal audio signal of an enrollment audio signal.

The computer may be further configured to, at a training phase: train the singer detector for generating the singer score using a training corpus including a plurality of training labels and a corresponding plurality of training audio signals having training vocal audio signals, each training label indicating a singer-specific vocal identity of the training vocal audio signal; and update one or more parameters of the singer detector based on a loss function using one or more training audio signals and one or more training labels.

The second set of acoustic features may be used to generate the vocalprint embedding includes at least one of: pitch contours, timbral texture, vibrato patterns, phoneme elongation, or harmonic structure.

The computer may be further configured to: segment the input audio signal into a plurality of time-based segments; identify one or more vocal audio segments by applying the singing detector to the plurality of time-based segments to identify each time-based segment having a vocal audio segment; and generate the vocal audio signal including one or more vocal audio segments of the plurality of segments of the input audio signal.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components of an example system for handling and analyzing audio data of inbound media data, according to an embodiment.

FIG. 2 shows dataflow amongst components of a system for detecting machine-generated synthetic vocal detection (singer liveness detection) in vocal signals, according to embodiments.

FIG. 3 shows dataflow amongst components of a system for singer verification and detecting machine-generated synthetic vocal detection (singer liveness detection) in vocal signals, according to embodiments.

FIG. 4 is flowchart illustrating operations of a computer-implemented method or process for detecting machine-generated singing vocal signals in an input audio signal, according to embodiments.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Singing voice synthesis and conversion technologies have advanced rapidly, enabling the generation of machine-produced singing vocals that closely mimic the acoustic and stylistic characteristics of real human singers, sometimes referred to as “deepfakes.” These technologies are increasingly used in entertainment, social media, and music production, and have also raised concerns regarding authenticity, copyright infringement, and impersonation. Music labels, streaming platforms, and content moderation systems may implement software tools to distinguish between genuine and synthetic machine-generated singing vocals in order to, for example, enforce licensing agreements, protect artist identity, and maintain content integrity.

Conventional deepfake detection systems are designed for speech-based applications and fail to generalize to singing vocals. These systems typically rely on acoustic features and classification models trained on spoken language corpora. However, singing vocals differ significantly from speech in pitch range, phoneme duration, harmonic structure, and the presence of musical accompaniment. As a result, speech-optimized detection systems exhibit reduced accuracy and robustness when applied to synthetic singing content.

Existing detection systems also lack mechanisms for accurately isolating singing vocals from instrumental or background audio, which can obscure certain artifacts in the acoustic features that are indicative of vocal signals. Furthermore, the existing systems do not incorporate training data or augmentation strategies that reflect the unique distortions and transformations present in synthetic singing, such as pitch modulation, tempo variation, and timbral smoothing. Consequently, current approaches exhibit reduced accuracy and robustness when applied to machine-generated singing vocals.

In addition, conventional systems do not provide functionality for determining whether a synthetic singing voice imitates a specific human singer. This limitation presents challenges for applications involving copyright enforcement, artist attribution, and content authenticity verification.

Embodiments described herein address these shortcomings by implementing a multi-stage, end-to-end machine-learning architecture programmed and trained for singing voice deepfake detection. The system includes a singing detection module that filters audio segments to identify singing vocals, a feature extraction pipeline that generates multiple acoustic representations (e.g., cepstral coefficients, constant-Q transform features, and self-supervised embeddings), and an ensemble of classification models trained on singing-specific datasets. In some cases, the system applies score-level fusion to combine model outputs and generate a final classification score indicating whether the input audio contains machine-generated singing vocals.

Embodiments may further include singing-specific data augmentation operations, such as pitch shifting, tempo perturbation, tremolo modulation, loudness normalization, and compression artifact simulation. These augmentations robustness of the machine-learning models of the embedding extractors, singing liveness detector, and singer detector, varying features or characteristics of real-world audio signals, including those audio signals having vocal audio signals. The embodiments may include singer or artist-specific vocalprint enrollment, enabling the machine-learning architecture to identify machine-generated, synthetic vocals that mimic known singers.

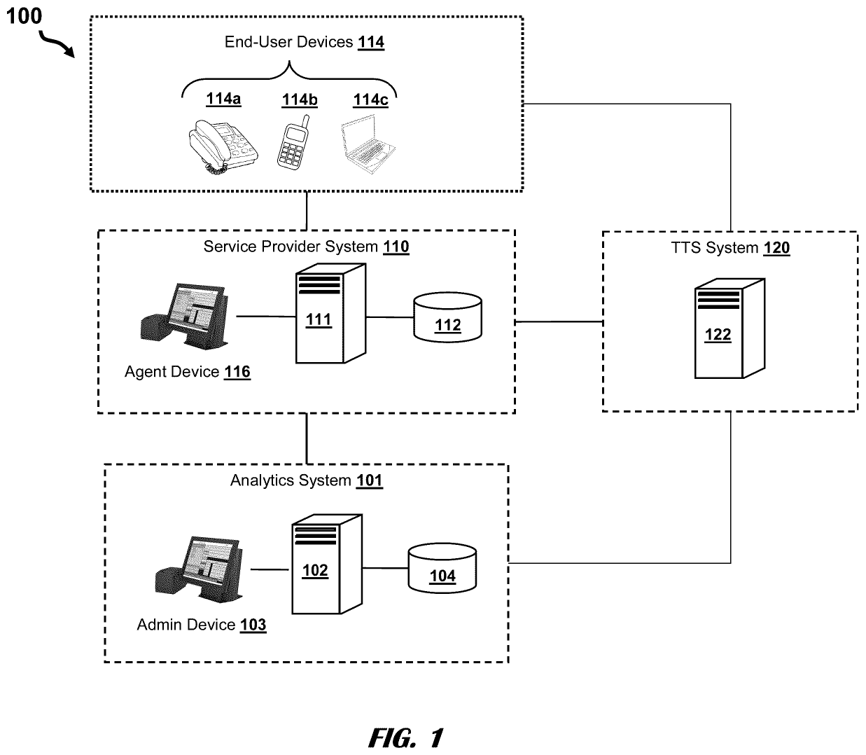

FIG. 1 shows components of an example system 100 for handling and analyzing audio data of inbound media data, according to an embodiment. The system 100 comprises an analytics system 101, service provider systems 110 of various types of enterprises (e.g., companies, government entities, universities, social media sites), a text-to-speech (TTS) system 120, and one or more end-user devices 114a-114c, including landline phones 114a, mobile phones 114b, and computing devices 114c (generally referred to as the end-user devices 114 or the end-user device 114). The analytics system 101 includes analytics servers 102, analytics databases 104, and admin devices 103. The service provider system 110 includes provider servers 111, provider databases 112, and agent devices 116. The TTS system 120 includes TTS servers 122 or other computing devices or components (e.g., TTS databases).

Embodiments may comprise additional or alternative components or omit certain components from what is shown in FIG. 1, and still fall within the scope of this disclosure. It may be common for the system 100 to, for example, omit any TTS system 120, include multiple TTS systems 120, omit any service provider systems 110, or include multiple provider systems 110, among other potential variations. It should also be appreciated that embodiments may include or otherwise implement any number of devices capable of performing the various features and tasks described herein. For example, the FIG. 1 shows the analytics server 102 as a distinct computing device from the analytics database 104, though in some embodiments, the analytics database 104 may be integrated into the analytics server 102.

The one or more networks of the system 100 include hardware and software components of public or private networks that interconnect the components of the system 100 and host or conduct audio communications containing singing vocals originated at the end-user devices 114. Non-limiting examples of such networks include Local Area Network (LAN), Wireless Local Area Network (WLAN), Metropolitan Area Network (MAN), Wide Area Network (WAN), and the Internet. Communications over the networks may be performed in accordance with protocols such as Transmission Control Protocol and Internet Protocol (TCP/IP), User Datagram Protocol (UDP), and IEEE communication protocols. The end-user devices 114 may communicate with destination systems (e.g., service provider systems 110, TTS system 120) via telephony and telecommunications protocols, hardware, and software capable of hosting, transporting, and exchanging audio data containing singing vocals. Non-limiting examples of telecommunications hardware include switches and trunks, among other hardware used for hosting, routing, or managing audio transmissions, circuits, and signaling. Non-limiting examples of telecommunications software and protocols include SS7, SIGTRAN, SCTP, ISDN, and DNIS, among others. Various entities may manage or organize the components of the telecommunications systems, including carriers, exchanges, and network operators.

The system 100 may include one or more network system infrastructures 101, 110, 120, including the analytics system 101, the provider system 110, and optionally the TTS system 120. The network system infrastructures 101, 110, 120 include physically and/or logically related collections of software and electronic devices managed or operated by various enterprise organizations. The devices of each network system infrastructure 101, 110, 120 are configured to provide the intended services of the particular enterprise organizations.

The end-user devices 114 may be any communications or computing device configured to transmit audio data containing singing vocals to a destination system, such as the service provider system 110 or the TTS system 120. The end-user device 114 may comprise, or be coupled to, a microphone for capturing genuine singing vocals or may execute software for generating synthetic singing vocals. Non-limiting examples of end-user devices 114 may include landline phones 114a and mobile phones 114b. The end-user device 114 is not limited to telecommunications-oriented devices. For example, the end-user device 114 may include a computing device 114c or Internet of Things (IoT) device configured to transmit audio data via voice-over-IP (VoIP) or other networked communications protocols. In some implementations, the computing device 114c may be a smart device or voice assistant device configured to generate synthetic singing vocals using locally installed singing synthesis software or to capture genuine singing vocals using an integrated microphone.

The end-user device 114 transmits audio data containing singing vocals to the service provider system 110 or textual instructions to the TTS system 120. The end-user device 114 and components of telephony networks, carrier systems, or computing communications networks perform operations for handling and routing the audio data, including interpretation, processing, transmission, and routing to the appropriate destination. In some cases, the audio data is captured by a microphone of the end-user device 114 or generated by the TTS system 120. The service provider system 110 or the TTS system 120 transmits the audio data and associated metadata to the analytics system 101 for analysis. The analytics system 101 performs various analytics and downstream audio processing operations, including singing voice detection, feature extraction, classification, and score fusion. The analytics servers 102, analytics databases 104, and admin devices 103 may each include or be hosted on any number of computing devices comprising a processor and software and capable of performing the processes described herein.

Optionally, the system 100 includes a TTS system 120. The TTS system 120 includes a TTS server 122 that executes software programming for generating synthetic singing vocals as audio signals based on text inputs or musical prompts received from an end-user device 114. The TTS server 122 or other device of the system 100 further executes software programming (e.g., encoder) for encoding audio signals containing singing vocals, including synthetic or genuine singing. The TTS server 122 or other device of the system 100 transmits the encoded audio signal and associated metadata to the analytics server 102 or other destination device for analysis. In some implementations, the end-user device 114 generates synthetic singing vocals locally using installed singing synthesis software.

The analytics system 101 is operated by an analytics service that provides various media data analysis services and operations, such as liveness detection (sometimes referred to as deepfake detection or spoof detection), and voice biometric identification or authentication (e.g., singer verification, speaker verification), among other types of analysis services. Components of the analytics system 101, such as the analytics server 102, execute various processes using audio data of various types of media data, in order to provide the various analytics services.

The service provider system 110 is operated by an enterprise organization (e.g., corporation, government entity, music label, streaming platform) that is a client of the analytics system 101. In an example implementation, the service provider system 110 receives audio data containing singing vocals from the end-user device 114. One or more devices of the service provider system 110, such as a provider server 111, may forward the audio data to the analytics system 101 via the one or more networks to perform the various analytics operations described herein. For example, the client of the service provider system 110 may be a music streaming platform that operates the service provider system 110 to ingest user-submitted content, including songs and vocal performances of artists or entertainment companies. As a client of the analytics service, the service provider system 110 of the streaming platform transmits the audio data of a media file (e.g., mp3) to the analytics system 101 for analysis. The analytics server 102 of the analytics system 101 applies one or more machine-learning architectures to perform operations, such as detecting machine-generated singing vocals, identifying synthesis artifacts, and generating classification scores for content moderation, artist attribution, or copyright enforcement. The service provider servers 111, provider databases 112, and agent devices 116 may each include or be hosted on any number of computing devices comprising a processor and software and capable of performing the processes described herein.

Turning to the analytics system 101, the analytics system 101 includes an analytics server 102 and an analytics database 104. The analytics database 104 may store corpora of training audio signals containing singing vocals, including genuine and synthetic samples, which are accessible to the analytics server 102 via one or more networks. In some implementations, the analytics database 104 includes training labels corresponding to the training audio signals. The training labels may indicate expected outputs for the training audio signals, such as expected classification scores, expected feature vector embeddings, expected synthesis method identifiers, or expected artist attribution scores. The analytics server 102 may execute supervised training operations to train one or more machine-learning models of the singing voice deepfake detection architecture. During training, the analytics server 102 references the training labels to adjust model parameters based on error metrics computed between predicted outputs and expected outputs. In some embodiments, an administrator configures the analytics server 102 to select training audio signals based on characteristics such as pitch range, vocal style, synthesis method, or presence of musical accompaniment.

The analytics server 102 of the call analytics system 101 may be any computing device comprising one or more processors and software, and capable of performing the various processes and tasks described herein. The analytics server 102 may host or be in communication with the analytics database 104 and may receive and process the audio data from the one or more service provider systems 110. Although FIG. 1 shows only a single analytics server 102, it should be appreciated that, in some embodiments, the analytics server 102 may include any number of computing devices. In some cases, the computing devices of the analytics server 102 may perform all or sub-parts of the processes and benefits of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the computing devices of the service provider system 110 (e.g., the service provider server 111).

The analytics server 102 includes software programming for executing one or more machine-learning models of a machine-learning architecture trained to detect machine-generated singing vocals and identify synthesis-related attributes within audio signal data. The machine-learning architecture includes task-specific sub-architectures configured to identify features indicative of synthesis artifacts and classify audio segments accordingly. These sub-architectures may include embedding extractors for generating feature vector embeddings using synthesis-indicative features (referred to as “fakeprints”), embedding extractors for generating feature vector embeddings using singing-specific vocalist recognition embedding (referred to as a “vocalprint”), vocalist or singer detectors, deepfake detectors for classifying audio segments as genuine or synthetic, attribute detectors for identifying synthesis method characteristics, and artist attribution classifiers for identifying whether the singing voice represents a known singer.

In some embodiments, the analytics server 102 applies feature extraction techniques tailored to singing-specific acoustic characteristics, including Constant-Q Transform (CQT) and Constant-Q Cepstral Coefficients (CQCC). The analytics server 102 segments the input audio signal into frames and applies a CQT transformation to capture harmonic content and pitch continuity across time. The CQCC features are derived from the CQT spectrum and provide cepstral representations that emphasize frequency resolution in musically relevant bands. These features are particularly effective for detecting synthesis artifacts in singing vocals, such as unnatural pitch transitions and timbral smoothing. The analytics server 102 may apply CQT and CQCC features in parallel with conventional features such as LFCC and LFB to generate multi-channel inputs for embedding extractors.

In some implementations, the embedding extractors include convolutional layers configured with attention mechanisms that dynamically adjust receptive fields based on input characteristics. The analytics server 102 applies these attention-based convolutional layers to focus on high-frequency regions and temporal discontinuities that are indicative of machine-generated singing. The attention mechanism assigns higher weights to regions of the input feature map that exhibit synthesis-related anomalies, such as abrupt pitch shifts or spectral flattening. The resulting embeddings encode localized synthesis artifacts and improve the sensitivity of downstream classifiers to deepfake singing signals.

In some embodiments, the analytics server 102 computes a magnitude value for each extracted embedding to represent the strength or reliability of the encoded features. The magnitude value may be calculated as the vector norm of the embedding and used to calibrate scoring thresholds in the liveness detector. Additionally, the analytics server 102 determines a net speech value for each input audio signal, representing the total duration of vocal segments identified by the singing detector. The net speech value may be used to filter out low-content samples or adjust the weighting of classification scores. These quality indicators enable adaptive scoring and improve robustness to short or noisy inputs.

The machine-learning architecture may include a fakeprint embedding extractor trained to extract features indicative of synthesis artifacts from audio signal data and generate a feature vector embedding representing those artifacts. The embedding extractor may implement a neural network architecture (e.g., ResNetSE34, wav2vec2.0, x-vector) configured to process acoustic features such as linear frequency cepstral coefficients (LFCC), linear filterbanks (LFB), or raw waveform segments. The embedding extractor may include convolutional layers, attention-based pooling layers, and fully connected layers trained using one or more loss functions to optimize classification accuracy. The resulting fakeprint embedding represents a compact vector encoding of synthesis-related characteristics in the input audio and, in some cases, metadata.

Fakeprints are feature vector embeddings that represent synthesis-related artifacts extracted from singing audio signals and, optionally, metadata associated with the audio data. The fakeprint embedding extractor may implement convolutional neural networks (CNNs), recurrent neural networks (RNNs), or self-supervised learning models. In CNN-based implementations, the input audio signal is transformed into a spectrogram and processed through convolutional and pooling layers to extract hierarchical features. The final layer outputs the fakeprint embedding. In RNN-based implementations, such as long short-term memory (LSTM) networks, the audio signal is segmented into frames and processed sequentially, with hidden states capturing temporal dependencies. The sequence of hidden states is aggregated to form the fakeprint embedding. In self-supervised implementations, such as wav2vec2.0, the model learns representations directly from raw waveform input, capturing both local and global synthesis artifacts.

Vocalprints are feature vector embeddings that represent singer-specific vocal identity characteristics extracted from vocal audio samples or vocal signals of audio signals. A vocalprint embedding extractor may implement convolutional neural networks (CNNs), recurrent neural networks (RNNs), or self-supervised learning models trained on singing-specific corpora. In CNN-based implementations, the input audio signal is transformed into a spectrogram and processed through convolutional and pooling layers to extract hierarchical features such as pitch contours, timbral texture, vibrato patterns, and phoneme elongation. The final layer outputs the vocalprint embedding. In RNN-based implementations, such as long short-term memory (LSTM) networks, the audio signal is segmented into frames and processed sequentially, with hidden states capturing temporal dependencies across melodic phrasing and vocal dynamics. The sequence of hidden states is aggregated to form and extract the vocalprint embedding. In self-supervised implementations, such as wav2vec2.0, the model learns representations directly from raw waveform input, capturing both local and global vocal identity features without requiring labeled data. The resulting vocalprint embedding may be used, for example, for singer verification, artist attribution, or similarity scoring against enrolled vocalprints, among other functions.

The analytics server 102 executes audio-processing software that includes a neural network architecture trained to perform singing voice deepfake detection, among other operations (e.g., fakeprint extraction, vocalprint extraction, singer detection). The neural network architecture operates logically in multiple operational phases, including a training phase, an enrollment phase, and a deployment phase (sometimes referred to as a test phase or inference phase). The analytics server 102 processes training audio signals during the training phase to optimize model parameters, generates enrollee embeddings from enrollment audio signals during the enrollment phase, and applies the trained architecture to inbound audio signals during the deployment phase. The analytics server 102 applies the neural network architecture to each type of input audio signal according to its corresponding operational phase.

The analytics server 102 or another computing device of the system 100 (e.g., service provider server 111) may perform pre-processing and data augmentation operations on input audio signals prior to or during execution of the neural network architecture. Pre-processing operations may include extracting low-level acoustic features from singing audio signals, segmenting the audio into frames or chunks, and applying transformation functions such as Short-Time Fourier Transform (STFT) or Fast Fourier Transform (FFT). Data augmentation operations may include pitch shifting, tempo perturbation, tremolo modulation, loudness normalization, reverberation, and compression artifact simulation. These augmentations simulate real-world singing variations and improve model robustness to synthesis artifacts. The analytics server 102 may execute these operations before feeding the audio signals into the input layers of the neural network architecture, or the architecture may include in-network augmentation layers that perform these operations during inference or training.

During the training phase, the analytics server 102 receives training audio signals containing singing vocals of varying lengths, styles, and acoustic characteristics from one or more corpora. These corpora may be stored in the analytics database 104 or another non-transitory storage medium. The training audio signals include clean singing samples and simulated singing signals generated through data augmentation. The clean samples contain genuine singing vocals with identifiable acoustic features. The simulated signals are generated by applying augmentation techniques that introduce synthesis-like distortions or artifacts, such as pitch modulation, tempo variation, reverberation, and compression. These augmentations simulate real-world variability and synthesis conditions to improve model generalization. The analytics server 102 stores the training audio signals and corresponding metadata into the analytics database 104 for use in training and evaluation operations of the neural network architecture.

As an example, the analytics server 102 executes a RawBoost augmentation operation configured to introduce various types of noise into training audio signals, such as linear and non-linear multiplicative noise and additive noise. In some cases, the analytics server 102 applies or injects music noise overlays to simulate background musical accompaniment. The RawBoost configuration parameters may be selected based on the synthesis method or target deployment environment to be simulated or trained against, such as social media platforms or streaming services. The augmented simulated training audio signals are used to train the fakeprint embedding extractor and singing liveness detector to recognize synthetic artifacts.

As another example, the analytics server 102 applies singing-specific augmentation techniques to simulate real-world vocal variability and synthesis artifacts. The analytics server 102 applies pitch shifting to simulate key changes, tempo perturbation to simulate speed variations, tremolo modulation to simulate amplitude fluctuations, and loudness normalization to simulate dynamic range compression. The analytics server 102 also applies compression artifact simulation using, e.g., MP3 or AAC, encoding to simulate lossy or lossless transmission effects. These augmentations are applied to both genuine and synthetic training samples to improve the robustness of the fakeprint extractor and singing liveness detector. The augmented samples are labeled and used to train the classifier layers to distinguish between human-generated and machine-generated singing vocals.

In some implementations, the analytics server 102 segments training audio signals into fixed-length chunks prior to augmentation and scoring, to generate vocal audio segments of a vocal audio signal and/or non-vocal segments. As an example, the analytics server 102 applies a segmenting function to divide or parse each audio signal into 4-second segments, discards segments shorter than 2 seconds, and/or pads segments between 2 and 4 seconds by repeating the input audio signal. The analytics server 102 applies the singing detection classifier of the singing detector to each segment and filters out segments lacking vocal content. The retained segments are augmented using RawBoost and other singing-specific synthetic operations, and used to train the machine-learning architecture. During deployment, the analytics server 102 applies segment-level scoring to inbound audio signals and aggregates segment scores using a fusion function, such as median or weighted average, to generate a singing detection classification score for the inbound audio signal.

During the training phase and, in some implementations, the enrollment phase, fully connected layers of the neural network architecture generate feature vector embeddings for each training audio signal. A loss function (e.g., large margin cosine loss (LMCL)) computes error values between predicted embeddings and expected embeddings derived from training labels. A classification layer adjusts weighted values (e.g., hyperparameters) of the neural network architecture to minimize the error and optimize the model's ability to distinguish between genuine and synthetic singing vocals. When the training phase concludes, the analytics server 102 stores the trained weights and model parameters into non-transitory storage media of the analytics server 102. During the enrollment and/or deployment phases, the analytics server 102 disables one or more layers of the neural network architecture, such as the classification layer or fully connected layers, to preserve the trained weights and prevent further modification during inference.

The analytics server 102 may train a vocalprint embedding extractor to generate feature vector embeddings (vocalprints) that represent singer-specific vocal identity characteristics. The analytics server 102 receives training audio signals containing singing vocals from a plurality of singers across diverse genres, languages, and vocal styles. The analytics server 102 applies pre-processing operations to extract acoustic features such as pitch contours, timbral texture, vibrato patterns, and phoneme elongation. The vocalprint embedding extractor comprises a neural network architecture trained to map these features into a compact vector space. A classification layer of the neural network architecture receives training labels indicating singer identity and adjusts model parameters to minimize a loss function (e.g., triplet loss, contrastive loss) that penalizes embedding overlap between different singers. The analytics server 102 stores the trained vocalprint extractor and associated weights into non-transitory storage media for use during enrollment and deployment phases.

Additionally or alternatively, the analytics server 102 may train a fakeprint embedding extractor to generate feature vector embeddings that represent synthesis-related artifacts in singing audio signals. The analytics server 102 receives training audio signals comprising both genuine and synthetic singing vocals, including samples generated using text-to-singing synthesis, voice conversion, and neural vocoding techniques. The analytics server 102 applies augmentation operations to simulate synthesis artifacts such as pitch smoothing, unnatural transitions, and timbral flattening. The fakeprint embedding extractor comprises a neural network architecture trained to distinguish between genuine and synthetic signals. A classification layer receives training labels indicating synthesis method or authenticity class and adjusts model parameters to minimize a loss function (e.g., binary cross-entropy, LMCL). The analytics server 102 stores the trained fakeprint extractor and associated weights into non-transitory storage media for use in downstream classification and scoring operations.

The analytics server 102 may trains the liveness detector to classify singing audio signals as either human-generated vocals or machine-generated synthetic vocals. The liveness detector comprises a neural network architecture that receives vocalprints and/or fakeprints as input and outputs a liveness score indicating the likelihood that the input vocal signal is human-generated or machine-generated. The analytics server 102 trains the liveness detector using labeled training data comprising both real and synthetic singing vocals. The analytics server 102 applies augmentation operations to introduce variability in acoustic conditions, including reverberation, background noise, and compression artifacts. A classification layer of the liveness detector adjusts model parameters to minimize a loss function (e.g., focal loss, hinge loss) that penalizes misclassification of synthetic signals. The analytics server 102 stores the trained liveness detector and associated weights into non-transitory storage media for use during deployment.

Optionally, the analytics server 102 may train a vocalist detector to identify the singer or vocalist associated with singing in a given vocal audio signal. The vocalist detector comprises a neural network architecture that receives vocalprint embeddings as input and outputs a classification score indicating the likelihood that the input signal matches a known singer. The analytics server 102 trains the vocalist detector using labeled training data comprising singing audio signals from a set of enrolled artists. The analytics server 102 applies pre-processing operations to normalize pitch range, tempo, and loudness across samples. A classification layer of the vocalist detector adjusts model parameters to minimize a loss function (e.g., categorical cross-entropy) that penalizes incorrect attribution. The analytics server 102 stores the trained vocalist detector and associated weights into non-transitory storage media for use in artist attribution and impersonation detection operations.

During an optional enrollment phase, the analytics server 102 applies the vocalprint embedding extractor to one or more enrollment audio signals having enrollment vocal signals associated with a known singer to generate a corresponding enrolled vocalprint. The analytics server 102 segments the enrollment audio into frames and extracts acoustic features such as pitch, timbre, and vibrato. The vocalprint embedding extractor processes the features to generate the vocalprint feature vector embedding that characterizes the singer's vocal identity. The analytics server 102 stores the enrolled vocalprint in association with a singer identifier in the analytics database 104. The enrolled vocalprint may be used during the deployment phase to compare against inbound vocalprints for vocalist singer identification, artist attribution, impersonation detection, or copyright enforcement, among other downstream operations.

During the enrollment phase, the analytics server 102 applies the fakeprint embedding extractor to one or more enrollment audio signals to generate a corresponding enrollee fakeprint. The enrollment audio signals may include known synthetic singing samples generated using specific synthesis methods or tools. The analytics server 102 extracts synthesis-related features from the audio signal and applies the fakeprint embedding extractor to generate a feature vector embedding that encodes synthesis artifacts. In some implementations, the fakeprint may additionally represent other types of data, such as metadata associated with the enrollment audio data. This metadata may include, for example, the synthesis method used to generate the audio, the model architecture or training corpus used by the synthesizer, or the file format and compression characteristics of the audio signal. The analytics server 102 stores the enrollee fakeprint in association with a synthesis method identifier, metadata tag, or class label in the analytics database 104. The enrollee fakeprint may be used during the deployment phase to compare against inbound fakeprints for synthesis method classification or deepfake detection, among others.

In some embodiments, following the training phase or enrollment phase, the analytics server 102 may disable some or all of the classification functions or classification layers of the machine-learning architecture to preserve or fix trained weights and prevent further modification during inference-time operations of the deployment phase.

During the deployment phase, the analytics server 102 receives an inbound audio signal containing a vocal signal of a singer, as originated from an end-user device 114 or TTS system 120. The analytics server 102 applies the layers of the trained machine-learning architecture, such as a vocalprint extractor and/or fakeprint extractor, to extract one or more embeddings from the inbound audio signal, including a vocalprint embedding representing singer-specific vocal identity characteristics and/or a fakeprint embedding representing synthesis-related artifacts. The analytics server 102 computes one or more similarity scores indicating similarities or distances between the inbound embeddings and corresponding trained clusters or optional enrolled embeddings stored in the analytics database 104. For example, the analytics server 102 may determine a vocalprint similarity score indicating a likelihood that the inbound caller matches an enrolled singer, and a fakeprint similarity score indicating a likelihood that the inbound vocal signal contains synthesis artifacts. The analytics server 102 applies a score fusion function to combine the similarity scores and generate a fused liveness score indicating whether the inbound vocal signal is likely genuine or synthetic. If the fused liveness score satisfies a predetermined threshold, the analytics server 102 identifies the inbound vocal signal as human-generated; otherwise, the analytics server 102 identifies the inbound vocal signal as synthetic or spoofed.

Following the deployment phase, the analytics server 102 (or another device of the system 100) may execute any number of various downstream operations that employ the various outputs of the machine-learning architecture, such as transmitting one or more notifications having machine-executable instructions for execution, and/or report data for display, by devices of the service provider system 110 (e.g., service provider server 111, agent device 116).

The analytics database 104 and/or the call center database 112 may contain any number of corpora of training audio signals containing singing vocals, including genuine and synthetic samples, which are accessible to the analytics server 102 via one or more networks. In some embodiments, the analytics server 102 employs supervised training to train one or more machine-learning models of the singing voice deepfake detection architecture. The analytics database 104 includes training labels corresponding to the training audio signals, where the training labels indicate expected outputs for the training audio signals, such as expected classification scores, expected feature vector embeddings, expected synthesis method identifiers, or expected artist attribution scores. The analytics server 102 may also query an external database (not shown) to access a third-party corpus of training audio signals, including singing-specific datasets. The analytics server 102 performs loss layers to adjust or update the weights or parameters in non-transitory memory for use during the optional enrollment phase and the deployment phase.

The analytics server 102 may execute one or more loss layers to train the singing detector using labeled training audio signals. The analytics server 102 segments the training audio signals into fixed-length chunks or segments and applies a singing detection classifier to each segment. The singing detector outputs predicted singing scores for each segment, which are compared against expected labels indicating the presence or absence of singing vocals. The loss layer computes an error value (or loss) between the predicted scores and the expected scores indicated by training labels using, for example, a binary cross-entropy loss function. The analytics server 102 adjusts the weights of the singing detector to minimize the loss and improve segment-level singing classification accuracy.

The analytics server 102 may execute one or more loss layers to train the fakeprint embedding extractor using training audio signals labeled as either human-generated or machine-generated. The analytics server 102 extracts acoustic features from each training sample and applies the fakeprint extractor to generate a feature vector embedding. The analytics server 102 applies a classifier of the singing liveness detector to the fakeprint embedding to produce a predicted liveness score. The loss layer computes an error value (or loss) between the predicted score and the expected score indicated by the training label using, for example, a large margin cosine loss (LMCL) or focal loss function. The analytics server 102 adjusts the parameters of the fakeprint extractor, scoring layers, or classifier of the singing liveness detector to minimize the loss and improve detection of synthesis artifacts.

The analytics server 102 may execute one or more loss layers to train the scoring layers or classifier layers of the singing liveness detector using predicted outputs from the liveness detector and expected outputs indicated by the training labels indicating, for example, expected liveness score or whether the training vocal signal is human-generated or machine-generated. The analytics server 102 applies a classifier to the fakeprint embedding to generate a predicted liveness score or other outputs. The loss layer computes an error value (or loss) between the predicted liveness score and the expected label using, for example, a hinge loss or binary cross-entropy loss function. The analytics server 102 updates the weights of the scoring layers or classifier of the singing liveness detector to minimize the loss and improve classification accuracy across diverse synthesis operations.

In some embodiments, the analytics server 102 may execute the one or more loss layers to train the vocalprint embedding extractor using training audio signals labeled with expected outputs, such as an expected singer identity. The analytics server 102 extracts acoustic features from each training sample and applies the vocalprint extractor to generate a feature vector embedding. The analytics server 102 applies a classifier to the embedding to produce a predicted singer identity score. The loss layer computes an error value between the predicted score and the expected label using a triplet loss or contrastive loss function. The analytics server 102 adjusts the parameters of the vocalprint extractor and classifier to minimize the loss and improve singer attribution performance.

In some embodiments, the analytics server 102 may execute the one or more loss layers to train the singer detector using vocalprint embeddings and training labels indicating the identity of the singer. The analytics server 102 applies a classifier to the vocalprint embedding to generate a predicted singer identity score. The loss layer computes an error value between the predicted score and the expected label using a categorical cross-entropy loss function. The analytics server 102 updates the weights of the classifier to minimize the loss and improve identification of known singers in synthetic vocal signals or genuine vocal signals.

Optionally, the analytics database 104 and/or the provider database 112 may store one or more corpora of enrollment audio signals, each comprising enrollment vocal signals associated with known or registered singers. The analytics server 102 applies a vocalprint embedding extractor to the enrollment vocal signals to generate corresponding vocalprint embeddings representing singer-specific vocal identity characteristics. In some implementations, the analytics server 102 segments the enrollment audio signals into time-based frames and extracts acoustic features including pitch contours, timbral texture, vibrato patterns, and phoneme elongation. The analytics server 102 applies a neural network architecture trained to map the extracted features into a compact vector space, generating a vocalprint embedding for each enrollment sample. The analytics server 102 stores the vocalprint embeddings in association with singer identifiers in the analytics database 104. The enrolled vocalprints may be used during the deployment phase to compare against inbound vocalprints for vocalist identification, artist attribution, impersonation detection, or copyright enforcement. In some embodiments, the analytics server 102 applies data augmentation operations to the enrollment audio signals prior to embedding extraction, including pitch shifting, tempo perturbation, tremolo modulation, and compression artifact simulation, to improve robustness of the vocalprint extractor to variance in real-world instances of inbound audio signals.

An administrator may operate the admin devices 103 or the agent devices 116 to access and configure the operations of machine-learning architecture of the analytics server 102. During training or enrollment, the analytics server 102 may access and/or generate, training or enrollment singing samples having various features or attributes to improve model generalization and to generate robust enrolled vocalprints. During deployment, the analytics server 102 may receive shorter singing samples, such as clips from social media or streaming platforms hosted at websites of the service provider server 111. In some implementations, the analytics server 102 applies singing-specific data augmentation operations to the training audio signals, including pitch shifting, tempo perturbation, tremolo modulation, loudness normalization, reverberation, and compression artifact simulation.

In an example implementation, the analytics system 101 receives inbound audio data from a music streaming platform of a service provider system 110 and applies a machine-learning architecture to determine whether the inbound audio data contains a vocal signal having acoustic features representing, and indicative of, machine-generated singing vocals. The analytics server 102 segments the inbound audio into time-based chunks, filters out non-singing segments using a singing detection classifier, and applies multiple classification models to the extracted acoustic features. The analytics server 102 and the analytics system 101 outputs one or more classification scores indicating, for example, singer detection score (sometimes referred to as an attribution score or the like) indicating a likelihood that acoustic features of the vocal signal represent and indicative of a particular vocalist; and/or a liveness score (sometimes referred to as a deepfake detection score or the like) indicating a likelihood that the vocal signal of the inbound audio data is likely a machine-generated synthetic vocal audio signal or human-generated vocal audio signal. The analytics server 102 may transmit the one or more scores to the service provider system 110 hosting the streaming platform and a notification indicating the whether the inbound audio signal is likely machine-generated content.

In another example implementation, the analytics server 102 receives a media file from a content moderation service, as hosted by the analytics system 101 or service provider system 110 and tasked with identifying impersonations of public figures. The analytics server 102 applies a vocalprint matching module to compare the singing voice in the media file against enrolled vocalprints of known artists. The analytics server 102 determines whether synthetic voice mimics a specific artist and outputs an attribution score, which the content moderation service of the service provider system 110 or analytics system 101 uses to flag potential copyright violations or impersonation risks.

In some implementations, the analytics system 101 receives audio data from a social media platform of a service provider system 110 that hosts media data containing music content. To train the machine-learning architecture, analytics server 102 includes pre-processing operations that apply various singing-specific data augmentation operations during training to improve the robustness of the machine-learning architecture to detect and analyze, for example, pitch shifts, tempo variations, and compression artifacts, among others. In some cases, the analytics server 102 applies a fusion function or machine-learning layers that combine outputs from the machine-learning layers of multiple classifiers and generate a final score indicating, for example, a likelihood whether a vocal signal is human-generated or machine-generated. The analytics server 102 then returns the one or more scores and notification to the service provider system 110, such that the social media platform uses the scores and notification to perform various downstream operations (e.g., prioritize moderation review of the media data at agent devices 116, apply indicator tags to the media data, takedown or remove the media data).

In another example implementation, the analytics system 101 receives audio data from the service provider system 110 of an entertainment company seeking to audit the media data of the service provider system 110 for unauthorized use of artist vocals using machine-generated vocal signals and/or machine-generated songs. Optionally, the analytics server 102 applies a metadata-based liveness detection engine having machine-learning models for analyzing various types of metadata, such as file format or source-indicator metadata, of the inbound audio data and the service provider system 110. The service provider system 110 provides enrollment data and metadata, such that analytics server 102 references to extract generate enrollment vocalprints associated with the enrolled artists and enrollment fakeprints associated with the enrollment media data and/or the service provider system 110. The analytics server 102 extracts inbound vocalprints for inbound media data and applies the artist-specific enrolled vocalprints to identify any matching enrolled artists using a singer detection model, and applies the liveness detection models to determine the likelihood whether the audio data contains synthetic vocals that imitate the identified enrolled artist. The analytics system 101 outputs a notification or report that, for example, indicates the one or more scores and identifies suspected synthetic content and associated artist matches.

In another example implementation, the analytics system 101 receives inbound audio data from a media hosting service of a service provider system 110, such as video hosting platform that supports music videos and karaoke performances. The analytics system 101 applies a singing detection classifier to detect vocal segments having instances of singing, and which may optionally include operations for isolating the vocal segments from instrumental backgrounds. The analytics system 101 may execute an embedding extractor that to extract the inbound features and inbound embeddings from raw waveform input of the inbound audio data. The analytics system 101 applies the liveness detection engine to generate one or more scores, such as a liveness score indicating whether the singing vocals are machine-generated.

The analytics server 102 applies the trained classification model of the singing liveness detector to the fakeprint embedding extracted from the input audio signal to generate a singing liveness score. The singing liveness score represents a likelihood that the vocal audio signal of the input audio signal is machine-generated. The analytics server 102 compares the singing liveness score against a detection threshold to determine whether the vocal audio signal satisfies a classification condition for detecting a machine-generated synthetic singing audio signal. If the singing liveness score satisfies the detection threshold, the analytics server 102 detects the vocal audio signal as containing machine-generated singing vocals. In some implementations, the analytics server 102 applies a score fusion function to combine the singing liveness score with one or more additional scores, such as a singer attribution score or a similarity score computed against enrolled fakeprints. The analytics server 102 compares the fused score against a detection threshold to detect machine-generated singing vocals in the input audio signal.

In response to detecting a machine-generated vocal audio signal, the analytics server 102 or other devices of the system 100 may execute any number of responsive or remedial operations.

For instance, in response to detecting a machine-generated vocal audio signal, the analytics server 102 may transmit a notification to one or more devices of the service provider system 110, such as the provider server 111 or agent device 116. The notification may include, for example, a classification label (or other indicator) that indicates the vocal audio signal is synthetic, a confidence score associated with the liveness score or input audio signal, and metadata describing the source and characteristics of the input audio signal. In some cases, the analytics server 102 or provider server 111 may store a detection notification in a content moderation queue or other non-transitory storage and include an indicator flag associated with input audio signal or associated media file, and/or apply an indicator for performing remedial actions on the media file containing the audio signal, such as removal, tagging, or licensing verification.

In some implementations, the analytics server 102 may transmit a machine-executable instruction to the provider server 111 or agent device 116 to initiate a takedown operation for the media file containing the machine-generated vocal audio signal. The provider server 111 may execute the instruction to remove the media file from a public-facing platform, restrict access to the file, or archive the file for further analysis. The agent device 116 may display a prompt to a human reviewer indicating the reason for the takedown and the classification score generated by the analytics server 102.

In other implementations, the analytics server 102 may generate and transmit a report to the provider database 112 or analytics database 104 for logging and auditing indicating that the particular media file containing the input audio signal contains machine-generated singing vocals. The report may indicate, for example, the detected synthesis operations used to generate the machine-generated singing vocals, the one or more scores (e.g., liveness score, fusion score, singer score), a timestamp of detection, and a singer identity indicator of the enrolled singer impersonated by the machine-generated singing vocals. The analytics database 104 or provider database 112 may store the report in association with the input audio signal.

In some embodiments, the analytics server 102 may transmit to the provider server 111 or agent devices 116 an indicator or notification containing a recommendation to apply a visual or textual indicator as a warning label to the media file, such as a “synthetic content” tag or a “deepfake warning” label. The provider server 111 may embed the indicator into the metadata of the media file or display the indicator alongside the media file on a user interface.

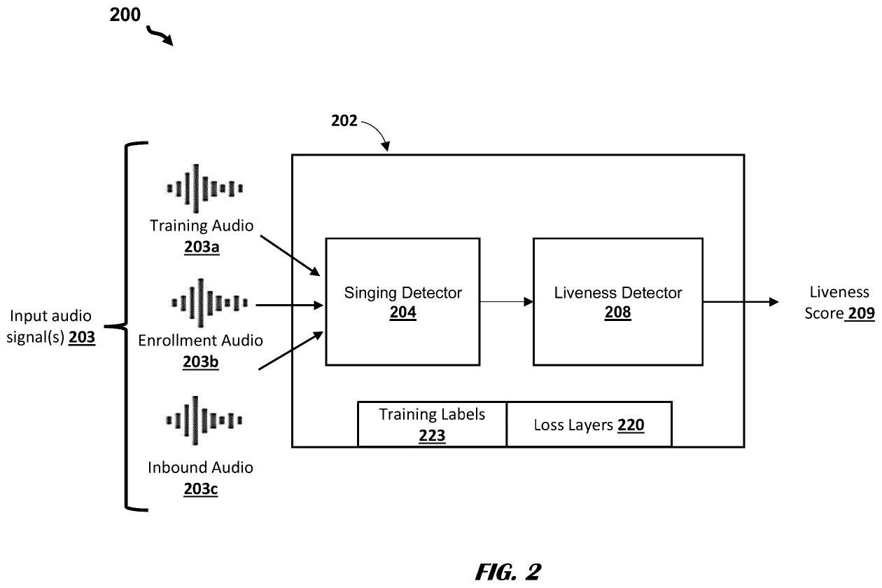

FIG. 2 shows dataflow amongst components of a system 200 for detecting machine-generated synthetic vocal detection (singer liveness detection) in vocal signals, according to embodiments. The system 200 includes a computing device, such as server (e.g., analytics server 102), executing software programming and routines that implement a machine-learning architecture 202 having machine-learning layers and functions for singing detection (referred to as a singing detector 204 for ease of description and understanding) and for singing liveness detection (referred to as a singing liveness detector 208 for ease of description and understanding). The machine-learning architecture 202 may further include any number of loss layers 220 for training, tuning, or otherwise adjusting the parameters or weights of the various machine-learning layers or functions (e.g., components of the singing detector 204, components of the singing liveness detector 208), using the various outputs of the machine-learning architecture 202, such as a singer liveness score 209 or other types of outputs (e.g., features, feature vector embeddings, classifications) as generated by the components of the machine-learning architecture 202.

Optionally, the machine-learning architecture 202 may execute the singing detector 204 and the singing liveness detector 208 concurrently to the input audio signal 203. The singing detector 204 identifies one or more segments of the input audio signal 203 containing vocal audio signals and outputs segment-level singing scores. The singing liveness detector 208 extracts a fakeprint embedding from the identified vocal segments and generates a liveness score 209 indicating a likelihood that the vocal audio signal is human-generated or machine-generated. The machine-learning architecture 202 may apply a score fusion function to combine the segment-level singing scores and the liveness score 209 into a final classification score for the input audio signal 203.

In some implementations, the machine-learning architecture 202 applies metadata-based routing logic to select model configurations for the singing detector 204 and the singing liveness detector 208. The computer (e.g., analytics server 102) executing the machine-learning architecture 202 receives metadata associated with the input audio signal 203, including file format, source platform, and encoding parameters. The machine-learning architecture 202 references the metadata to select model variants optimized for the input signal characteristics. For example, the machine-learning architecture 202 may select a singing detector 204 trained on high-fidelity studio recordings for FLAC files and a singing liveness detector 208 trained on compressed social media clips for MP3 files. The routing logic enables adaptive model selection and improves classification performance across diverse audio environments.

In some embodiments, the machine-learning architecture 202 applies a pre-trained singing detection classifier of the singing detector 204 to segment the input audio signal 203 prior to processing by the liveness detector 208. The singing detector 204 identifies time-based segments containing singing vocals and filters out non-singing segments. The machine-learning architecture 202 applies the singing liveness detector 208 to the retained singing vocal segments. In some cases, the classifier comprises a convolutional neural network trained on annotated singing corpora and outputs segment-level singing scores. The machine-learning architecture 202 applies a threshold to the singing scores to determine segment inclusion. This segmentation operations can improve model efficiency and reduces misclassification and analysis of instrumental or spoken content.

The software components of the machine-learning architecture 202 may be executed by any computing device comprising hardware (e.g., processor, non-transitory storage medium) and software components capable of performing operations of the machine-learning architecture 202, and/or by any number of such computing devices. The machine-learning architecture 202 operates according to various operational phases, including a training phase, enrollment phase, and deployment phase. In operation, the server hosting the machine-learning architecture 202 receives input audio signals 203a-203c (generally referred to as input audio signals 203) according to the particular phase, where the machine-learning architecture 202 receives training audio signals 203a at the training phase, enrollment audio signals 203b at the optional enrollment phase, and inbound audio signals 203c at the deployment phase. The machine-learning architecture 202 further receives and stores training labels 223 associated with the training audio signals 203a or, in some cases, the enrollment audio signals 203b, where the server hosting the machine-learning architecture 202 may receive the stores training labels 223 with the training audio signals 203a from another device or database, or otherwise stored in a non-transitory machine-readable storage media accessible to the server hosting and executing the machine-learning architecture 202.

The machine-learning architecture 202 includes one or more embedding extractors trained to extract various types of feature vector embeddings, one or more scoring layers or classifiers trained to generate various scores or outputs (e.g., liveness score 209, classification, features, feature vector embeddings, audio segments) and detect instances of machine-generated singing vocals.

The singing detector 204 is a software program having machine-learning layers configured and trained for analyzing input audio signals 203 and identifying or detecting vocal audios signals in the input audio signal 203, in which the vocal audio signals contain instances of vocalized singing in the input audio signal 203. The singing detector 204 includes functions and layers of a sub-component of the machine-learning architecture 202, including software routines implementing a machine-learning model trained and programmed to detect one or more vocalized singing utterances within an input audio signal 203.

The singing detector 204 obtains the input audio signal 203 and generates various types or forms of outputs. As an example, the singing detector 204 parses the input audio signal 203 into frames or segments containing instances of vocalized singing utterances detected by the singing detector 204. The singing detector 204 outputs a vocal signal comprising the vocalized singing portions of the input audio signal 203 containing the detected vocalized singing utterances. As another example, the singing detector 204 outputs timestamps or other metadata indicators associated with the input audio signal 203 indicating the instances of vocalized singing utterances that singing detector 204 detected in the input audio signal 203.

The singing detector 204 comprises a classifier trained to distinguish singing vocals from non-singing audio content, such as silence, instrumental music, spoken language, and background noise, among others. The classifier receives an input audio signal 203 and applies a set of transformation functions to extract acoustic features from the input audio signal 203. The extracted features may include and represent, for example, spectral descriptors, pitch contours, harmonic structure, and temporal dynamics. The singing detector 204 applies the trained classifier to the extracted features to generate a singing detection score indicating a likelihood that the input audio signal 203 contains singing vocals.

In some implementations, the classifier applies a threshold to the singing detection score to determine whether the input audio signal 203 includes a valid vocal signal suitable for downstream analysis. If the score satisfies the threshold, the classifier isolates the vocal segment from the input audio signal 203 and provides the detected vocal signal to the singing liveness detector 208 for further processing. The singing detector 204 may discard segments that fail to satisfy the singing detection threshold or tag such segments for exclusion from subsequent analysis.

In some embodiments, the classifier of the singing detector 204 is pre-trained on a corpus of labeled dataset of training audio signals 203a that include training vocal singing signals and non-vocal singing audio signals, including a cappella vocals, instrumental tracks, mixed audio recordings, or plain speech, among others. The classifier of the singing detector 204 may implement a neural network architecture trained to differentiate singing from other acoustic sources based on, for example, pitch modulation, phoneme elongation, and vibrato patterns, among others. The singing detector 204 may also reference metadata associated with the input audio signal 203, including file format, source platform, and content tags, to improve classification accuracy and support domain-specific operations.

As an example, upon receiving an input audio signal 203, the singing detector 204 applies a segmentation module to divide the input audio signal 203 into time-based chunks. The classifier of the singing detector 204 evaluates each segment using the trained model configured to detect singing vocals based on the types of acoustic features (e.g., pitch contours, harmonic structure, phoneme elongation, vibrato patterns). For each segment, the classifier generates a singing detection score indicating a likelihood that each segment or a collection of segments contains singing vocals. The classifier compares the singing detection score against a preconfigured singing detection threshold to determine whether the segment or set of segments qualifies as a vocal singing signal being detected in the input audio signal 203.

For segments that satisfy the singing threshold, the singing detector 204 isolates or parses the corresponding vocal singing signal, combines the singing segments into the vocal singing signal, and transmits the vocal singing signal to the singing liveness detector 208 for further analysis. The singing detector 204 may transmit the vocal singing signal as a discrete audio segment or as a continuous stream. In some implementations, the singing detector 204 tags each transmitted vocal singing signal with metadata indicating, for example, the segment boundaries, singing confidence score, and source identifier of the input audio signal 203, among others.

The singing detector 204 may discard segments that fail to satisfy the singing threshold or direct such segments to another component of the server for optional reprocessing. In some embodiments, the singing detector 204 applies a smoothing function to the sequence of singing detection scores to reduce false positives and improve temporal consistency. The singing detector 204 may also apply a post-filtering module to exclude segments with low signal-to-noise ratio or excessive background interference prior to forwarding the vocal signal to the singing liveness detector 208.

The singing liveness detector 208 comprises an embedding extractor and scoring layers trained to generate classification scores indicating whether an input vocal signal of an input audio signal 203 is likely human-generated or synthetic. The singing liveness detector 208 comprises a feature extraction engine, one or more embedding extractors, and scoring layers trained to generate liveness classification scores 209. The feature extraction engine applies one or more transformation functions to the received vocal signal to extract acoustic features, including cepstral coefficients, constant-Q transform features, and raw waveform representations. The embedding extractors generate feature vector embeddings from the extracted features, including a fakeprint embedding that is generated using features that may represent acoustic artifacts indicative of machine-generated vocal singing signals.

During the training phase, the singing liveness detector 208 receives training audio signals 203a comprising singing vocals of varying lengths, styles, and acoustic characteristics. The training audio signals 203a include human-generated singing samples and machine-generated synthetic singing samples generated using singing synthesis and voice conversion operations. The singing liveness detector 208 applies the embedding extractor to each training audio signal 203a to extract training acoustic features and training fakeprint embeddings.

The singing liveness detector 208 references training labels 223 associated with the training audio signals 203a. The training labels 223 indicate expected outputs for each training audio signal 203a, such as expected liveness scores 209 and expected fakeprint embeddings, among others. The singing liveness detector 208 applies scoring layers to the embeddings to generate the predicted liveness score 209, among other possible outputs, for each training sample. The singing liveness detector 208 applies one or more loss layers 220 to compute error values between the predicted outputs and the expected outputs indicated by the training labels 223.

The one or more loss layers 220 and the singing liveness detector 208 adjust model parameters of the scoring layers and embedding extractors based on the computed error values. The singing liveness detector 208 applies a supervised learning algorithm to minimize the error values and optimize the ability of the model of the scoring layers to distinguish between genuine and synthetic singing vocals. In some implementations, the singing liveness detector 208 applies singing-specific data augmentation operations (e.g., pitch shifting, tempo perturbation, tremolo modulation, loudness normalization, reverberation, compression artifact simulation) to the training audio signals 203a, prior to feature extraction. The singing liveness detector 208 stores the trained weights and model parameters of the embedding extractor and/or the scoring layers in non-transitory storage media for use during enrollment and deployment phases.

During a deployment phase, the singing liveness detector 208 receives an inbound audio signal 203c comprising inbound vocal singing signals extracted from media data or streaming audio sources by the singing detector 204. The singing liveness detector 208 applies the embedding extractor to extract inbound acoustic features (e.g., cepstral coefficients, constant-Q transform features, raw waveform representations) and then generates an inbound fakeprint embedding representing synthesis-related artifacts in the inbound vocal signal, using the acoustic features extracted from the inbound audio signals 203c.

In some embodiments, the singing liveness detector 208 operates without an enrollment phase. The scoring layers of the singing liveness detector 208 apply a trained classification model to the inbound fakeprint embedding to generate a liveness score 209 indicating a likelihood that the inbound audio signal 203c contains machine-generated singing vocals. In some cases, the singing liveness detector 208 compares the liveness score 209 against a preconfigured threshold to classify the inbound audio signal 203c as human-generated or machine-generated synthetic singing. The singing liveness detector 208 may transmit the classification result to downstream engines or devices for content moderation, copyright enforcement, or risk scoring, among other downstream operations.

In some embodiments, the singing liveness detector 208 operates with an optional enrollment phase. In such embodiments, the analytics server 102 applies the fakeprint embedding extractor to one or more enrollment audio signals 203b to generate corresponding enrolled fakeprints. The enrolled fakeprints may include extracted enrolled features representing, for example, known singing-synthesis methods, synthetic singing tools, or previously observed synthesis artifacts. During deployment, the singing liveness detector 208 compares the inbound fakeprint embedding extracted from the inbound audio signal 203c against one or more enrolled fakeprints to compute a similarity score. The scoring layers of the singing liveness detector 208 apply a distance metric to determine whether the inbound fakeprint matches or is within a threshold distance from one or more enrolled fakeprints representing the various known synthesis patterns. In some implementations, the singing liveness detector 208 applies a score fusion function that combines the similarity score with the liveness classification score 209 to generate a fused liveness score. The fused liveness score is compared against a threshold to classify the inbound audio signal 203c as human-generated or machine-generated singing vocals.

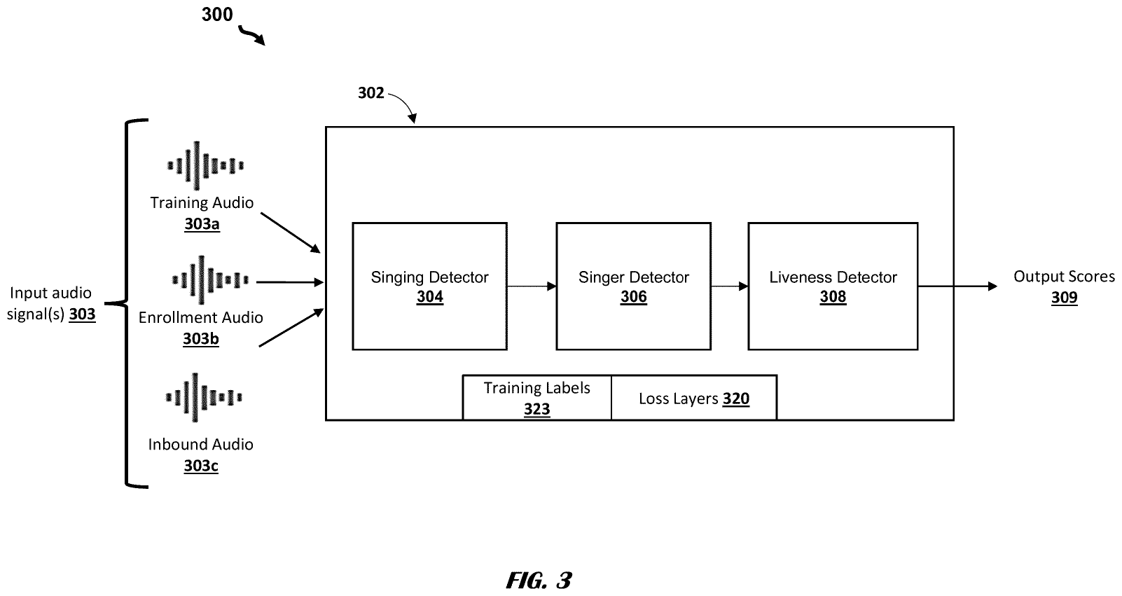

FIG. 3 shows dataflow amongst components of a system 300 for singer verification and detecting machine-generated synthetic vocal detection (singer liveness detection) in vocal signals, according to embodiments. The system 300 includes a computing device, such as server (e.g., analytics server 102), executing software programming and routines that implement a machine-learning architecture 302 having machine-learning layers and functions for singing detection (referred to as a singing detector 304 for ease of description and understanding), singer identification detection (referred to as a singer detector 306 for ease of description and understanding), and singing liveness detection (referred to as a singing liveness detector 308 for ease of description and understanding). The machine-learning architecture 302 may further include any number of loss layers 320 for training, tuning, or otherwise adjusting the parameters or weights of the various machine-learning layers or functions, such as the singing detector 304, singer detector 306, and/or the one or more liveness detector 308, using the various outputs of the machine-learning architecture 302, such as detection scores 309 or other types of outputs (e.g., features, feature vector embeddings, classifications) as generated by components of the machine-learning architecture 302.

In some embodiments, the machine-learning architecture 302 includes parallel scoring paths for singer identification and singing liveness detection. In such embodiments, the machine-learning architecture 302 applies a singer detector 306 and a liveness detector 308 concurrently to the input audio signal 303. The singer detector 306 extracts a vocalprint embedding and generates a singer attribution score (as an output score 309) indicating a likelihood that the input audio signal 303 matches an enrolled singer. The liveness detector 308 extracts a fakeprint embedding and generates a liveness score (as an additional or alternative output score 309) indicating a likelihood that the input audio signal 303 contains machine-generated singing vocals. In some cases, the machine-learning architecture 302 applies a score fusion function to combine the singer attribution score and the singing liveness score into a final classification score (as an additional or alternative output score 309) for the input audio signal 303.

In some implementations, the machine-learning architecture 302 applies metadata-based routing logic to select model configurations for the singer detector 306 and the liveness detector 308. The computer (e.g., analytics server 102) executing the machine-learning architecture 302 receives metadata associated with the input audio signal 303, including file format, source platform, and encoding parameters. The machine-learning architecture 302 references the metadata to select model variants optimized for the input signal characteristics. For example, the machine-learning architecture 302 may select a singer detector 306 trained on high-fidelity studio recordings for FLAC files and a singing liveness detector 308 trained on compressed social media clips for MP3 files. The routing logic enables adaptive model selection and improves classification performance across diverse audio environments.

In some embodiments, the machine-learning architecture 302 applies a pre-trained singing detection classifier of the singing detector 304 to segment the input audio signal 303 prior to processing by the singer detector 306 and the singing liveness detector 308. The classifier of the singing detector 304 identifies time-based segments containing singing vocals and filters out non-singing segments. The machine-learning architecture 302 applies the singer detector 306 and the singing liveness detector 308 to the retained singing vocal segments. In some cases, the classifier of the singing detector 304 comprises a convolutional neural network trained on annotated singing corpora and outputs segment-level singing scores. The machine-learning architecture 302 applies a threshold to the singing scores to determine segment inclusion as the singing vocal signal. This segmentation improves model efficiency and reduces misclassification or analysis of instrumental or spoken content.

The software components of the machine-learning architecture 302 may be executed by any computing device comprising hardware (e.g., processor, non-transitory storage medium) and software components capable of performing operations of the machine-learning architecture 302, and/or by any number of such computing devices. The machine-learning architecture 302 operates according to various operational phases, including a training phase, enrollment phase, and deployment phase. In operation, the server hosting the machine-learning architecture 302 receives input audio signals 303a-303c (generally referred to as input audio signals 303) according to the particular phase, where the machine-learning architecture 302 receives training audio signals 303a at the training phase, enrollment audio signals 303b at the optional enrollment phase, and inbound audio signals 303c at the deployment phase. The machine-learning architecture 302 further receives and stores training labels 323 associated with the training audio signals 303a or, in some cases, the enrollment audio signals 303b, where the server hosting the machine-learning architecture 302 may receive the stores training labels 323 with the training audio signals 303a from another device or database, or otherwise stored in a non-transitory machine-readable storage media accessible to the server hosting and executing the machine-learning architecture 302.

The machine-learning architecture 302 includes one or more embedding extractors trained to extract various types of feature vector embeddings, one or more scoring layers or classifiers trained to generate various scores 309 or outputs (e.g., singer detection score, liveness detection score, classifications, features, feature vector embeddings, audio segments) and detect instances of particular singers and machine-generated singing vocals.

The singing detector 304 is a software program having machine-learning layers configured and trained for analyzing input audio signals 303 and identifying or detecting vocal audios signals in the input audio signal 303, in which the vocal audio signals contain instances of vocalized singing in the input audio signal 303. The singing detector 304 includes functions and layers of a sub-component of the machine-learning architecture 302, including software routines implementing a machine-learning model trained and programmed to detect one or more vocalized singing utterances within an input audio signal 303.

The singing detector 304 obtains the input audio signal 303 and generates various types or forms of outputs. As an example, the singing detector 304 parses the input audio signal 303 into frames or segments containing instances of vocalized singing utterances detected by the singing detector 304. The singing detector 304 outputs a vocal signal comprising the vocalized singing portions of the input audio signal 303 containing the detected vocalized singing utterances. As another example, the singing detector 304 outputs timestamps or other metadata indicators associated with the input audio signal 303 indicating the instances of vocalized singing utterances that singing detector 304 detected in the input audio signal 303.

The singing detector 304 comprises a classifier trained to distinguish singing vocals from non-singing audio content, such as silence, instrumental music, spoken language, and background noise, among others. The classifier receives an input audio signal 303 and applies a set of transformation functions to extract acoustic features from the input audio signal 303. The extracted features may include and represent, for example, spectral descriptors, pitch contours, harmonic structure, and temporal dynamics. The singing detector 304 applies the trained classifier to the extracted features to generate a singing detection score indicating a likelihood that the input audio signal 303 contains singing vocals.

In some implementations, the classifier applies a threshold to the singing detection score to determine whether the input audio signal 303 includes a valid vocal signal suitable for downstream analysis. If the score satisfies the threshold, the classifier isolates the vocal segment from the input audio signal 303 and provides the detected vocal signal to the singing liveness detector 308 for further processing. The singing detector 304 may discard segments that fail to satisfy the singing detection threshold or tag such segments for exclusion from subsequent analysis.

In some embodiments, the classifier of the singing detector 304 is trained on a corpus of labeled training dataset of training audio signals 303a that include training vocal singing signals and non-vocal singing audio signals, including a cappella vocals, instrumental tracks, mixed audio recordings, or plain speech, among others. The classifier of the singing detector 304 may implement a neural network architecture trained to differentiate singing from other acoustic sources based on, for example, pitch modulation, phoneme elongation, and vibrato patterns, among others. The singing detector 304 may also reference metadata associated with the input audio signal 303, including file format, source platform, and content tags, to improve classification accuracy and support domain-specific operations. The labeled training dataset includes the training audio signals 303a and corresponding training labels 323, indicating certain expected attributes or information about the corresponding training audio signals 303a, which indicate certain expected outputs for the particular training audio signals 303a (e.g., expected features, expected feature vectors, expected classification as containing singing). Alternatively, the machine-learning architecture 302 may implement and incorporate a pre-trained singing detector 304.

In an example operation, upon receiving an input audio signal 303 (e.g., training audio signals 303a, enrollment audio signals 303b, inbound audio signal 303c), the singing detector 304 applies a segmentation engine programmed and trained to divide or parse the input audio signal 303 into time-based chunks. The classifier of the singing detector 304 evaluates each segment using the trained model configured to detect singing vocals based on the types of acoustic features (e.g., pitch contours, harmonic structure, phoneme elongation, vibrato patterns). For each segment, the classifier generates a singing detection score indicating a likelihood that each segment or a set of segments of the input audio signal 303 contains singing vocals. The classifier compares the singing detection score against a preconfigured singing detection threshold to determine whether the segment or set of segments qualifies as a vocal singing signal being detected in the input audio signal 303.

For segments that satisfy the singing threshold, the singing detector 304 isolates or parses the corresponding vocal singing signal, combines the singing segments into the vocal singing signal, and transmits the vocal singing signal to the singer detector 306 and/or the singing liveness detector 308 for further analysis. The singing detector 304 may transmit the vocal singing signal as a discrete audio segment or as a continuous stream. In some implementations, the singing detector 304 tags each transmitted vocal singing signal with metadata indicating, for example, the segment boundaries, singing confidence score, and source identifier of the input audio signal 303, among others.

The singing detector 304 may discard segments that fail to satisfy the singing threshold or direct such segments to another component of the server for optional reprocessing. In some embodiments, the singing detector 304 applies a smoothing function to the sequence of singing detection scores to reduce false positives and improve temporal consistency. The singing detector 304 may also apply a post-filtering module to exclude segments with low signal-to-noise ratio or excessive background interference prior to forwarding the vocal signal to the singer detector 306 and/or the singing liveness detector 308.

The machine-learning architecture 302 forwards one or more outputs (e.g., vocal singing signals of the input audio signals 303) produced by the singing detector 304, to the singer detector 306. The singer detector 306 ingests these outputs from the machine-learning architecture 302, and identifies or detects a particular singer in the input audio signal 303.

The singer detector 306 receives vocal singing signals from the singing detector 304 and applies a feature extraction engine and embedding extractor trained to generate vocalprint embeddings representing singer-specific vocal identity characteristics using the features extracted from the vocal signing signal of the input audio signal 303. The feature extraction engine of the singer detector 306 may apply one or more transformation functions to the vocal singing signal to extract acoustic features, including pitch contours, timbral texture, vibrato patterns, and phoneme elongation, among others. The embedding extractor applies a neural network architecture trained to extract or map the extracted features into a vector space and representing features indicative of a particular singer. The singer detector 306 generates a vocalprint embedding for each vocal singing signal received from the singing detector 304.

The singer detector 306 applies scoring layers trained to determine the identity of a singer based on a distance metric computed between the inbound vocalprint embedding and one or more enrolled vocalprints. The scoring layers may implement a cosine similarity function, probabilistic linear discriminant analysis (PLDA), or other distance-based classifier. The singer detector 306 generates a singer attribution score indicating a likelihood that the inbound vocal singing signal matches a known or registered singer. The singer detector 306 may transmit the singer attribution score and the vocalprint embedding to the singing liveness detector 308 for further analysis.

In some cases, the singer detector 306 may also tag the vocalprint embedding with metadata indicating, for example, the source of the vocal signal, the segment boundaries, and the confidence level of the singer attribution score. The singing liveness detector 308 may reference the vocalprint embedding and associated metadata to calibrate liveness scoring operations or to support downstream operations of, for example, impersonation detection and copyright enforcement, among others.

During a training phase, the singer detector 306 receives training audio signals 303a comprising singing vocals from a plurality of singers across diverse genres, languages, and vocal styles. The singer detector 306 applies the embedding extractor to each training audio signal 303a to extract training acoustic features and generates a training vocalprint embedding for each training sample.

The singer detector 306 references training labels 323 indicating an expected singer identity for each training audio signal 303a. The scoring layers of the singer detector 306 apply a classification model to the training vocalprint embeddings and compute predicted singer identity scores. The singer detector 306 applies one or more loss layers 320 to compute error values between the predicted outputs (e.g., predicted training vocalprints, predicted singer scores) and the expected outputs (e.g., expected training vocalprints, expected singer scores) indicated by the training labels. The loss layers 320 and/or the singer detector 306 adjusts model parameters of the embedding extractor and scoring layers of the singer detector 306 to minimize the error values and optimize the model's ability to distinguish between different singers. The singer detector 306 stores the trained weights and model parameters in non-transitory storage media for use during enrollment and deployment phases.

During an enrollment phase, the singer detector 306 receives one or more enrollment audio signals 306b comprising singing vocals associated with a known or registered singer. The singer detector 306 applies the embedding extractor to each enrollment audio signal 306b to generate a corresponding enrolled vocalprint embedding. The singer detector 306 may algorithmically combine multiple enrolled vocalprints of multiple one or more enrollment audio signals 306b of the enrolled singer to generate or update the enrolled vocalprint for particular singer. The singer detector 306 stores the enrolled vocalprint in association with a singer identifier in a database (e.g., analytics database 104 or provider database 112). The enrolled vocalprint may be used during the deployment phase to compare against inbound vocalprint embeddings for singer identification, impersonation detection, or copyright enforcement.

During the training phase or the enrollment phase, the singer detector 306 may apply one or more data augmentation operations to the training audio signals 306a prior to feature extraction. The data augmentation operations simulate real-world acoustic variability and improve the robustness of the embedding extractor and scoring layers to variations in pitch, tempo, timbre, and recording conditions. The data augmentation operations may include, for example, pitch shifting to simulate variations of musical keys, tempo perturbation to simulate speed variations, tremolo modulation to simulate amplitude fluctuations, loudness normalization to simulate dynamic range compression, reverberation to simulate room acoustics, and compression artifact simulation to simulate encoding effects associated with MP3 or MP4 formats.

The singer detector 306 may apply the data augmentation operations dynamically during training or enrollment, such that each batch or dataset of training audio signals 303a includes a mixture of original and augmented samples. The singer detector 306 may apply augmentation parameters randomly or within configured limits to introduce controlled variability. The scoring layers and loss layers 320 may reference both original and augmented samples when computing error values and adjusting model parameters, as indicated by the training labels 323.

During the deployment phase, the singer detector 306 receives inbound audio signals 306c comprising inbound vocal singing signals extracted by the singing detector 304. The singer detector 306 applies the embedding extractor to each inbound vocal signal to extract inbound acoustic features (e.g., pitch contours, timbral texture, vibrato patterns, phoneme elongation), and applies the trained neural network architecture to generate an inbound vocalprint embedding representing singer-specific vocal identity characteristics in the inbound vocal signal.

The singer detector 306 applies the trained scoring layers trained to determine the identity of the inbound singer based on a distance metric computed between the inbound vocalprint embedding and one or more enrolled vocalprints, as stored in the server or other device. The scoring layers may implement a cosine similarity function, probabilistic linear discriminant analysis (PLDA), or other distance-based classifier. The singer detector 306 generates a singer attribution score (sometimes referred to as a singer detection score) indicating a likelihood that the inbound singer matches a known or registered singer.

The singer detector 306 may transmit the singer attribution score and the inbound vocalprint embedding to the singing liveness detector 308 for further analysis. The singing liveness detector 308 may reference the singer attribution score to calibrate liveness scoring operations or to support various downstream operations. In some embodiments, the singer detector 306 tags the inbound vocalprint embedding with metadata indicating the source of the inbound audio signal 303c, the segment boundaries, and the confidence level of the singer attribution score.

The machine-learning architecture 302 forwards any number of outputs produced by the singer detector 306 and/or the singing detector 304 to the singing liveness detector 308. The singing liveness detector 308 may detect instances of human-generated singing vocals or machine-generated singing vocals in the input audio signal 303. The singing liveness detector 308 then outputs the various output scores 309, among other types of outputs (e.g., classification indicators).

The singing liveness detector 308 comprises layers of neural network architecture that function as an embedding extractor trained to extract fakeprint embeddings for the input audio signal 303, and scoring layers trained to generate the various classification indicators and/or output scores 309, including classification liveness detection scores indicating whether an input vocal signal of an input audio signal 303 is likely human-generated or synthetic. The singing liveness detector 308 comprises a feature extraction engine of one or more embedding extractors, and scoring layers trained to generate liveness classification scores 309. The feature extraction engine applies one or more transformation functions to the received vocal signal to extract acoustic features, including cepstral coefficients, constant-Q transform features, and raw waveform representations. The embedding extractors generate feature vector embeddings from the extracted features, including a fakeprint embedding that is generated using features that may represent acoustic artifacts indicative of machine-generated vocal singing signals.

During the training phase, the singing liveness detector 308 receives training audio signals 303a comprising singing vocals of varying lengths, styles, and acoustic characteristics. The training audio signals 303a include human-generated singing samples and machine-generated synthetic singing samples generated using singing synthesis and voice conversion operations. The singing liveness detector 308 applies the embedding extractor to each training audio signal 303a to extract training acoustic features and training fakeprint embeddings.

The singing liveness detector 308 references training labels 323 associated with the training audio signals 303a. The training labels 323 indicate expected outputs for each training audio signal 303a, such as expected liveness scores 309 and expected fakeprint embeddings, among others. The singing liveness detector 308 applies scoring layers to the embeddings to generate the predicted liveness score 309, among other possible outputs, for each training sample. The singing liveness detector 308 applies one or more loss layers 320 to compute error values between the predicted outputs and the expected outputs indicated by the training labels 323.

The one or more loss layers 320 and the singing liveness detector 308 adjust model parameters of the scoring layers and embedding extractors based on the computed error values. The singing liveness detector 308 applies a supervised learning algorithm to minimize the error values and optimize the ability of the model of the scoring layers to distinguish between genuine and synthetic singing vocals. In some implementations, the singing liveness detector 308 applies singing-specific data augmentation operations (e.g., pitch shifting, tempo perturbation, tremolo modulation, loudness normalization, reverberation, compression artifact simulation) to the training audio signals 303a, prior to feature extraction. The singing liveness detector 308 stores the trained weights and model parameters of the embedding extractor and/or the scoring layers in non-transitory storage media for use during enrollment and deployment phases.

During a deployment phase, the singing liveness detector 308 receives an inbound audio signal 303c comprising inbound vocal singing signals extracted from media data or streaming audio sources by the singing detector 304. The singing liveness detector 308 applies the embedding extractor to extract inbound acoustic features (e.g., cepstral coefficients, constant-Q transform features, raw waveform representations), including the acoustic features that may be related to synthesis-related artifacts indicative of machine-generated synthetic vocal signals. Using the acoustic features extracted from the inbound audio signals 303c, the singing liveness detector 308 generates an inbound fakeprint embedding representing certain types of acoustic feature or other types of data (e.g., metadata related to the inbound audio signal 303c) for liveness detection.

In some embodiments, the singing liveness detector 308 operates without an enrollment phase. The scoring layers of the singing liveness detector 308 apply the trained classification model to the inbound fakeprint embedding to generate a liveness score indicating a likelihood that the inbound audio signal 303c contains machine-generated singing vocals. In some cases, the singing liveness detector 308 compares the liveness score against a preconfigured threshold to classify the inbound audio signal 303c as human-generated or machine-generated synthetic singing. The singing liveness detector 308 may generate and output the various types of detection scores 309 or classification indicators.

In some cases, the singing liveness detector 308 may transmit the various detection scores 309 and classification results to downstream engines or devices for content moderation, copyright enforcement, or risk scoring, among other downstream operations.

In some embodiments, the singing liveness detector 308 operates with the optional enrollment phase. In such embodiments, the machine-learning architecture 302 applies the fakeprint embedding extractor to one or more enrollment audio signals 303b to generate corresponding enrolled fakeprints. The enrolled fakeprints may include extracted enrolled features representing, for example, known singing-synthesis methods, synthetic singing tools, or previously observed synthesis artifacts. During deployment, the singing liveness detector 308 compares the inbound fakeprint embedding extracted from the inbound audio signal 303c against one or more enrolled fakeprints to compute a similarity score. The scoring layers of the singing liveness detector 308 apply a distance metric to determine whether the inbound fakeprint matches or is within a threshold distance from one or more enrolled fakeprints representing various known synthesis patterns.

In such optional enrollment phase of the singing liveness detector 308, the machine-learning architecture 302 applies the fakeprint embedding extractor to one or more enrollment audio signals 303b to generate a corresponding enrollee fakeprint. The enrollment audio signals may include known synthetic singing samples generated using specific synthesis methods or tools. The feature extraction engine of the singing liveness detector 308 extracts synthesis-related features from the audio signal and applies the fakeprint embedding extractor to generate a fakeprint feature vector embedding that encodes and represents synthesis artifacts in the enrollment audio signals 303b.

In some implementations, the fakeprint may additionally represent other types of data, such as metadata associated with the enrollment audio data associated with the enrollment audio signals 303b. This metadata may include, for example, the synthesis method used to generate the particular input audio signal 303 (e.g., enrollment audio signals 303b, inbound audio signal 303c), the artifacts resulting from vocalization software (e.g., TTS software, deepfake software), or the file format or compression characteristics of the particular input audio signal 303. The computer hosting and executing the machine-learning architecture 302 stores the enrolled fakeprint in association with, for example, a vocalization software identifier, metadata tag, or class label indicator in a database. At the deployment phase, the singing liveness detector 308 extracts an inbound fakeprint for a inbound audio signal 303c and compares the inbound fakeprint against the enrolled fakeprints to generate one or more similarity scores, which the singing liveness detector 308 outputs as liveness classification scores of the one or more detection scores 309.

In some implementations, the singing liveness detector 308 applies a score fusion function that combines the similarity scores with the liveness classification score to generate a fused liveness score. The fused liveness score is compared against a threshold to classify the input audio signal 303 as human-generated or machine-generated singing vocals.

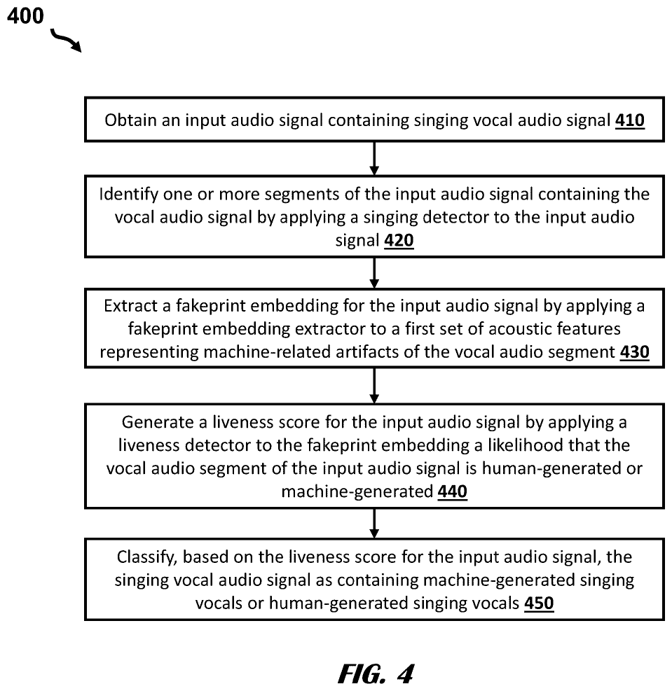

FIG. 4 is flowchart illustrating operations of a computer-implemented method or process 400 for detecting machine-generated singing vocal signals in an input audio signal, according to embodiments. The method 400 includes operations performed by one or more computing devices having one or more processors executing a trained machine-learning architecture configured to analyze acoustic features of vocal segments and classify the singing vocals as either human-generated or machine-generated.

Embodiments may include any number of additional or alternative features or operations, or omit certain features or operations, of the method 400 and still fall within the scope of this disclosure. For ease of description and understanding, the operations and features of the method 400 are described as being performed by a computer having at least one processor, though embodiments may be performed by various types of computing devices, and any number of computing devices, having one or more processors capable of performing the various features and operations described herein.

At operation 410, the computer obtains an input audio signal containing a singing vocal audio signal. The input audio signal may include one or more vocal segments representing sung utterances (captured in the vocal audio signal) of a singer. The computer may obtain the input audio signals during any of the operational phases of a machine-learning architecture, including a training phase, optional enrollment phase, and deployment phase (sometimes referred to as “testing,”“inference time,”or the like).

During the training phase, the computer may obtain training audio signals from a training corpus stored in a database, such as a local analytics database or a remote repository accessible via a network. The training audio signals may include genuine singing vocals and machine-generated synthetic singing vocals generated using machine-executed programming for generating machine-generate audio signals (e.g., text-to-singing synthesis, voice conversion, neural vocoding operations).

During the enrollment phase, the computing device may obtain enrollment audio signals containing singing vocals associated with a known singer, for example, from a service provider server or an end-user device configured to transmit artist-specific, enrollment vocal audio signals (having enrollment vocal samples of singing) in enrollment audio signals for the known singer.

During the deployment phase, the computing device may obtain inbound audio signals from service provider servers hosting streaming platforms or content moderation services or end-user devices (e.g., end-user computing devices). In some embodiments, the computer may receive the input audio signal as a media file (e.g., MP3, WAV) or as a data stream transmitted over a telecommunications or computing network. The input audio signal may be accompanied by metadata indicating the source platform, file format, or synthesis method, which may be used in detecting singing liveness and various downstream processing operations.

In some embodiments, the computer segments the input audio signal into a plurality of time-based segments and applies a singing detector to each segment to identify one or more vocal audio segments. The computer generates a vocal audio signal comprising the identified vocal audio segments of the input audio signal. The input audio signal may be received from an end-user device, a service provider system, or a database storing training or enrollment corpora. The input audio signal may include metadata indicating file format, source platform, or synthesis method (software operations for generating machine-generated vocal audio signal), which may be used to support domain-specific processing.

At operation 420, the computer identifies portions of the input audio signal containing the vocal audio signal by applying a singing detector to the input audio signal. The singing detector comprises layers of the machine-learning architecture that include a singing classifier, programmed and trained to distinguish singing vocal signals from non-singing signals (e.g., silence, instrumental audio content, spoken content). The computer applies the singing detector to the input audio signal to isolate time-based segments that contain vocal utterances exhibiting melodic, rhythmic, or harmonic characteristics associated with singing. In some embodiments, the singing detector implements a neural network architecture trained on labeled singing and non-singing audio samples, including a cappella vocals, instrumental tracks, and mixed audio compositions.

The computer may apply the singing detector during any operational phase of the machine-learning architecture. During the training phase, the computer applies the singing detector to training audio signals to filter out non-singing segments prior to feature extraction and model optimization. During the enrollment phase, the computer applies the singing detector to enrollment audio signals to isolate vocal segments associated with a known singer for generating enrolled vocalprints. During the deployment phase, the computer applies the singing detector to inbound audio signals received from end-user devices or provider systems to identify vocal segments for downstream classification. In some implementations, the computer segments the input audio signal into fixed-length frames or segments (e.g., 2-4 seconds) and applies the singing detector to each segment to determine whether the segment contains singing vocals. The computer may discard segments that do not satisfy a singing likelihood threshold or may annotate such segments for exclusion from subsequent processing operations of the method 400.

At operation 430, the computer extracts a fakeprint embedding for the input audio signal by applying a fakeprint embedding extractor to a first set of acoustic features representing machine-related artifacts of the vocal audio segment. The fakeprint embedding extractor comprises a trained neural network architecture configured to generate a compact feature vector encoding synthesis-related characteristics of the vocal signal. The computer applies the fakeprint embedding extractor to the vocal audio segment (as identified in operation 420), using acoustic features that may include, for example, linear frequency cepstral coefficients (LFCC), linear filterbank features (LFB), or raw waveform representations. These features may be extracted using signal processing functions and operation, such as Short-Time Fourier Transform (STFT), Fast Fourier Transform (FFT), or convolutional operations, among others.

In some embodiments, the fakeprint embedding extractor comprises a convolutional neural network (CNN), a time-delay neural network (TDNN), or a self-supervised learning model (e.g., wav2vec2.0). The computer may apply the extractor during any operational phase of the machine-learning architecture. During the training phase, the computer applies the fakeprint embedding extractor to training audio signals labeled as genuine or synthetic, and adjusts model parameters using a loss function (e.g., binary cross-entropy, large margin cosine loss) to optimize classification accuracy. During an optional enrollment phase, the computer applies the fakeprint embedding extractor to enrollment audio signals generated using known synthesis operations to generate enrolled fakeprints for known operations for generating machine-generated singing vocal signals. During the deployment phase, the computer applies the fakeprint embedding extractor to inbound audio signals received from end-user devices or provider systems to generate the fakeprint embedding for detecting the singing liveness.

The fakeprint embedding represents features indicative of machine-generated encoding of the vocal audio segment, capturing machine-generated artifacts, such as pitch smoothing, unnatural phoneme transitions, timbral flattening, and compression distortions, among others.

In some implementations, the computer may augment the input audio signal prior to extraction using data augmentation techniques such as pitch shifting, tempo perturbation, reverberation, or loudness normalization. These data augmentation operations inject the types of data augmentations to the training audio signals in order to simulate the various types of machine-generated features and artifacts that the machine-learning architecture may receive during the deployment phase (or enrollment phase), forcing the machine-learning architecture to train on the simulated types of training audio signals, thereby improving the robustness of the machine-learning models of the components of the machine-learning architecture, such as the fakeprint embedding extractor and singing liveness detector, among others. The resulting fakeprint embedding is used in subsequent operations to assess the likelihood that the vocal audio segment is machine-generated by the singing liveness detector.

At operation 440, the computer generates a singing liveness score for the input audio signal by applying the singing liveness detector to the fakeprint embedding, which indicates the likelihood that the vocal audio segment of the input audio signal is a human-generated singing vocal signal or a machine-generated singing vocal signal. The liveness detector comprises layers of the machine-learning architecture including a classification model configured to receive the fakeprint embedding as input from the fakeprint embedding extractor of the liveness detector. The liveness detector outputs the liveness score representing the probability or likelihood that the singing vocal audio signal is human-generated singing audio or machine-generated singing audio.

During the training phase, the computer applies the liveness detector to the fakeprint embeddings extracted from training audio signals labeled as either genuine or synthetic. The computer adjusts model parameters using a loss function (e.g., focal loss, hinge loss, binary cross-entropy) to optimize the separation between human-generated and machine-generated singing vocals. In some implementations, the computer applies data augmentation techniques to the training audio signals prior to extraction, including pitch modulation, reverberation, and compression artifact simulation, to improve model robustness to synthesis-related distortions. In some implementations, the singing liveness detector includes calibration or loss layers that adjust the singing liveness score based on signal quality metrics or acoustic variability, such as pitch modulation, compression artifacts, or reverberation.

The computer may apply the liveness detector according to the operational phases of the machine-learning architecture, including a training phase and deployment phase. The machine-learning architecture including the singing liveness detector may include embodiments with or without an enrollment phase.

During the deployment phase, in embodiments without an enrollment phase, the computer generates a singing liveness score for the input audio signal by applying the singing liveness detector to the inbound fakeprint embedding extracted using the inbound features of the inbound audio signal. The liveness detector comprises a trained classification model configured to operate in a zero-shot or non-enrollment mode, in which the singing liveness detector evaluates the authenticity of the vocal audio signal based on the inbound features encoded in the inbound fakeprint embedding. The computer applies the trained singing liveness detector to the inbound fakeprint embedding extracted from the inbound audio signal and computes a singing liveness score representing the likelihood that the vocal signal is human-generated or machine-generated.

The signing liveness detector references classification boundaries, clusters, centroids, or learned feature distributions derived during the training phase. The singing liveness detector may implement a neural network architecture trained to distinguish genuine singing vocals from synthetic, machine-generated vocals using labeled training data (without comparing an inbound fakeprint embedding for an inbound audio signal against enrolled fakeprint embeddings stored in a database). The computer may apply thresholding logic to the singing liveness score to classify the vocal signal as human-generated or machine-generated (as in a later operation 450). The deployment phase may be used in real-time streaming environments, content moderation systems, or endpoint devices where capturing enrollment audio signals are impractical or unavailable.

During the deployment phase, in embodiments with an enrollment phase, the computer generates a singing liveness score for the input audio signal by applying the liveness detector to the inbound fakeprint and one or more enrolled fakeprints, where the liveness detector retrieves one or more enrolled fakeprints, as generated during a prior enrollment phase by the fakeprint embedding extractor, from a database. The computer compares the inbound fakeprint embedding against a set of enrolled fakeprint embeddings stored in the database, each representing synthetic-related artifacts extracted from known machine-generated singing vocal audio signals. The computer generates one or more similarity scores indicating the degree of similarity or distance between the inbound fakeprint and the enrolled fakeprints. The liveness detector applies a scoring function to the similarity scores to generate the singing liveness score, indicating a likelihood that the vocal audio segment of the input audio signal is a human-generated singing vocal signal or a machine-generated singing vocal signal.

In some embodiments, the singing liveness detector includes layers of a classifier trained to interpret similarity scores in conjunction with additional features of the inbound fakeprint, such as magnitude, spectral variance, or temporal discontinuities, among others. The computer may apply a threshold to the singing liveness score to classify the vocal signal as genuine or synthetic. In other embodiments, the singing liveness detector executes a score fusion function to algorithmically combine the similarity scores, which may include outputs or scores generated from other components of the machine-learning architecture (e.g., singer detector). The enrollment-based configuration improves detection accuracy for known software operations for generating machine-generated vocal audio signals, enabling the computer to identify specific synthetic techniques or platforms associated with the input audio signal.

At operation 450, the computer classifies, based on the singing liveness score for the input audio signal, the signing vocal audio signal of the input audio signal as containing machine-generated singing vocals or human-generated singing vocals.

The singing liveness detector performs a classification function to the singing liveness score, as generated by the liveness detector (as in operation 440). In configurations where an enrollment phase is present, the singing liveness score may reflect one or more similarity scores between the inbound fakeprint embedding and one or more enrolled fakeprints representing known operations for generating machine-generated vocal audio signals or synthetic vocal artifacts of machine-generated vocal signals. The singing liveness detector compares the singing liveness score against a preconfigured classification threshold to determine whether the vocal audio segment is likely to be machine-generated or human-generated. The classification function may include, for example, a binary decision layer, a probabilistic classifier, or a rule-based logic engine configured to interpret the score in the context of known synthesis features.

In configurations where an enrollment phase is not implemented, the singing liveness detector classifies, based on the singing liveness score for the input audio signal, the singing vocal audio signal of the input audio signal as containing machine-generated singing vocals or human-generated singing vocals. The singing liveness score is generated by applying a trained liveness detector to the fakeprint embedding, without reference to any enrolled fakeprints. The liveness detector comprises a classification model trained to distinguish between human-generated vocal signals and machine-generated vocal signals vocals, as trained using labeled training data. The computer applies a thresholding function to the singing liveness score to determine whether the vocal audio segment satisfies a singing liveness detection threshold. If the score satisfies the threshold, the computer classifies the vocal signal as human-generated; otherwise, the computer classifies the vocal signal as machine-generated.

In some implementations, the classification function may incorporate additional calibration logic based on signal quality metrics or acoustic variability, such as pitch continuity, timbral richness, or compression artifacts. The classification result may be used to trigger downstream operations, including content moderation, artist attribution, or copyright enforcement. The computer may annotate the input audio signal with a classification label or transmit a notification to a service provider system indicating the classification outcome. This configuration supports deployment in environments where enrollment of synthetic reference samples is impractical or unavailable, such as real-time streaming platforms or endpoint devices.

The classification result may be used to trigger downstream operations, such as content moderation, artist attribution, or copyright enforcement. In some implementations, the computer may annotate the input audio signal with a classification label indicating the authenticity of the singing vocals, or transmit a notification to a service provider system indicating the classification outcome. The classification may also be used to prioritize review of flagged content or to apply policy-based actions, such as removal, tagging, or licensing verification.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for detecting machine-generated singing in audio signals, the method comprising:
obtaining, by a computer, an input audio signal containing singing vocal audio signal;
identifying, by the computer, one or more segments of the input audio signal containing the vocal audio signal by applying a singing detector to the input audio signal;
extracting, by the computer, a fakeprint embedding for the input audio signal by applying a fakeprint embedding extractor to a first set of acoustic features representing machine-related artifacts of the vocal audio segment;
generating, by the computer, a singing liveness score for the input audio signal by applying a liveness detector to the fakeprint embedding, the singing liveness score indicating a likelihood that the vocal audio segment of the input audio signal is human-generated or machine-generated; and
classifying, by the computer, based on the liveness score for the input audio signal, the singing vocal audio signal as containing machine-generated singing vocals or human-generated singing vocals.

2. The method according to claim 1, further comprising:
at a training phase:
training, by the computer, the singing liveness detector for generating the liveness score using a training corpus comprising a plurality of training label and a corresponding plurality of training audio signals having training vocal audio signals, a training label indicating a corresponding training audio signal includes human-generated vocal audio signal or machine-generated vocal audio signal; and
updating, by the computer, one or more parameters of the singing liveness detector based on a loss function using each training audio signal and each training label.

3. The method according to claim 1, further comprising:
at an enrollment phase,
extracting, by the computer, one or more enrolled fakeprint embeddings by applying the fakeprint embedding extractor to one or more enrollment vocal audio signals of one or more enrollment audio signals having known machine-generated vocal audio signals,
wherein the computer generates the liveness score for the input audio signal based upon comparing the input audio fakeprint against at least one enrolled fakeprint embedding.

4. The method according to claim 1, wherein the first set of acoustic features used to generate the fakeprint embedding representing at least one of: pitch smoothing, phoneme distortion, unnatural transitions, or timbre flattening.

5. The method according to claim 1, further comprising:
at a deployment phase:
extracting, by the computer, an input vocalprint embedding for the input audio signal by applying a vocalprint embedding extractor of a singer detector to a second set of acoustic features representing a singer-specific vocal identity of the vocal audio signal of the input audio signal; and
generating, by the computer, a singer score indicating an enrolled singer in the vocal audio signal using the singer detector, based upon comparing the input vocalprint embedding and one or more enrolled vocalprint embeddings.

6. The method according to claim 5, further comprising identifying, by the computer, the enrolled singer in the vocal audio signal using the singer detector based upon comparing the singer score against a singer detection threshold.

7. The method according to claim 5, further comprising:
at an enrollment phase:
extracting, by the computer, an enrolled vocalprint embedding for the enrolled singer by applying the vocalprint embedding extractor to the second set of acoustic features representing the singer-specific vocal identity of an enrollment vocal audio signal of an enrollment audio signal.

8. The method according to claim 5, further comprising:
at a training phase,
training, by the computer, the singer detector for generating the singer score using a training corpus comprising a plurality of training labels and a corresponding plurality of training audio signals having training vocal audio signals, a training label indicating a corresponding training audio signal includes the singer-specific vocal identity of the training vocal audio signal of the training audio signal; and
updating, by the computer, one or more parameters of the singer detector based on a loss function using one or more training audio signals and one or more training label.

9. The method according to claim 5, wherein the second set of acoustic features used to generate the vocalprint embedding representing at least one of: pitch contours, timbral texture, vibrato patterns, phoneme elongation, or harmonic structure.

10. The method according to claim 1, further comprising:
segmenting, by the computer, the input audio signal into a plurality of time-based segments;
identifying, by the computer, one or more vocal audio segments by applying a singing detector to the plurality of time-based segments to identify each time-based segment having a vocal audio segment; and
generating, by the computer, the vocal audio signal having one or more vocal audio segments of the plurality of segments of the input audio signal.

11. A system for detecting machine-generated singing in audio signals, the system comprising:
a computer comprising at least one processor, configured to:
obtain an input audio signal containing a singing vocal audio signal;
identify one or more segments of the input audio signal containing the vocal audio signal by applying a singing detector to the input audio signal;
extract a fakeprint embedding for the input audio signal by applying a fakeprint embedding extractor to a first set of acoustic features representing machine-related artifacts of the vocal audio segment;
generate a liveness score for the input audio signal by applying a liveness detector to the fakeprint embedding, the singing liveness score indicating a likelihood that the vocal audio segment of the input audio signal is human-generated or machine-generated; and
classify the singing vocal audio signal as containing machine-generated singing vocals or human-generated singing vocals based on the singing liveness score.

12. The system of claim 11, wherein the computer is further configured to:
at a training phase:
train the singing liveness detector for generating the liveness score using a training corpus comprising a plurality of training labels and a corresponding plurality of training audio signals having training vocal audio signals, each training label indicating whether a corresponding training audio signal includes human-generated or machine-generated vocal audio; and
update one or more parameters of the singing liveness detector based on a loss function using each training audio signal and each training label.

13. The system of claim 11, wherein the computer is further configured to:
at an enrollment phase:
extract one or more enrolled fakeprint embeddings by applying the fakeprint embedding extractor to one or more enrollment vocal audio signals of one or more enrollment audio signals having known machine-generated vocal audio signals; and
generate the liveness score for the input audio signal based upon comparing the input audio fakeprint against at least one enrolled fakeprint embedding.

14. The system of claim 11, wherein the first set of acoustic features used to generate the fakeprint embedding comprises at least one of: pitch smoothing, phoneme distortion, unnatural transitions, or timbre flattening.

15. The system of claim 11, wherein the computer is further configured to:
at a deployment phase:
extract an input vocalprint embedding for the input audio signal by applying a vocalprint embedding extractor of a singer detector to a second set of acoustic features representing a singer-specific vocal identity of the vocal audio signal of the input audio signal; and
generate a singer score indicating an enrolled singer in the vocal audio signal using the singer detector, based upon comparing the input vocalprint embedding and one or more enrolled vocalprint embeddings.

16. The system of claim 15, wherein the computer is further configured to identify the enrolled singer in the vocal audio signal using the singer detector based upon comparing the singer score against a singer detection threshold.

17. The system of claim 15, wherein the computer is further configured to:
at an enrollment phase:
extract an enrolled vocalprint embedding for the enrolled singer by applying the vocalprint embedding extractor to the second set of acoustic features representing the singer-specific vocal identity of an enrollment vocal audio signal of an enrollment audio signal.

18. The system of claim 15, wherein the computer is further configured to:
at a training phase:
train the singer detector for generating the singer score using a training corpus comprising a plurality of training labels and a corresponding plurality of training audio signals having training vocal audio signals, each training label indicating a singer-specific vocal identity of the training vocal audio signal; and
update one or more parameters of the singer detector based on a loss function using one or more training audio signals and one or more training labels.

19. The system of claim 15, wherein the second set of acoustic features used to generate the vocalprint embedding comprises at least one of: pitch contours, timbral texture, vibrato patterns, phoneme elongation, or harmonic structure.

20. The system of claim 11, wherein the computer is further configured to:
segment the input audio signal into a plurality of time-based segments;
identify one or more vocal audio segments by applying the singing detector to the plurality of time-based segments to identify each time-based segment having a vocal audio segment; and
generate the vocal audio signal comprising one or more vocal audio segments of the plurality of segments of the input audio signal.
